(19) United States
(12) Patent Application Publication
(10) Pub. No.: US 2019/0145740 A1
(43) Pub. Date: May 16, 2019

(54) Impact Absorbing Structures in Body Protective Equipment

(71) Applicants: VICIS, Inc., Seattle, WA (US); University of Washington, Seattle, WA (US)

(72) Inventors: Mike Czerski, Seattle, WA (US); Anton Alferness, Seattle, WA (US); Adam Frank, Seattle, WA (US); David Marver, Seattle, WA (US); Jason Neubauer, Seattle, WA (US); Gary Kaplan, Seattle, WA (US); Per Reinhall, Seattle, WA (US); Samuel Browd, Seattle, WA (US)

(21) Appl. No.: 16/246,827

(22) Filed: Jan. 14, 2019

Related U.S. Application Data
(63) Continuation of application No. PCT/US2017/042138, filed on Jul. 14, 2017.
(60) Provisional application No. 62/363,096, filed on Jul. 15, 2016.

(51) Int. Cl. F41H 1/02; A41D 13/015; A41D 13/05; B32B 5/18; B32B 5/02; B32B 5/24; B32B 27/12; B32B 27/06; B32B 27/36; B32B 27/40; F41H 5/04

(52) U.S. Cl. CPC F41H 1/02; B32B 2571/02; A41D 13/0518; B32B 5/18; B32B 5/02; B32B 5/245; B32B 27/12; B32B 27/065; B32B 27/365; B32B 27/40; F41H 5/0492; A41D 2600/10; A41D 2500/50; B32B 2307/558; B32B 2262/0269; B32B 2266/0278; A41D 13/015

(57) ABSTRACT

Disclosed are systems, methods, procedures and devices incorporating a variety of impact absorbing structures (IAS) and/or buckling structure arrays into protective garments, vests and/or other items, which can greatly enhance wearer comfort, improve garment durability, improve wearer athletic performance, reduce cost of manufacture and/or minimize impact forces and trauma to the wearer's body.

### CROSS-REFERENCE TO RELATED APPLICATIONS

This application claims the claims the priority of Patent Cooperation Treaty Application Serial No. PCT/US2017/042138, entitled “Impact Absorbing Structures In Body Protective Equipment,” filed on Jul. 14, 2017, which claims the benefit of U.S. Provisional Patent Application Ser. No. 62/363,096 entitled “Impact Absorbing Structures In Body Protective Equipment,” filed Jul. 15, 2016, the disclosures of which are incorporated by reference herein in its entireties.

### TECHNICAL FIELD

The present invention relates to devices, system and methods for incorporating impact absorbing materials, impact absorbing structures, buckling structures and/or various combinations thereof into body protective equipment such as athletic pads and/or equipment, as well as other types of protective equipment such as combat armor, bullet resistant vests, helmets, neckwear, footwear, gloves, arms and/or leg coverings or other clothing or pads for the wearer to desirably minimize, reduce, delay and/or redirect the transmission of impact forces to various locations on the wearer's anatomy. In various embodiments, wearer-specific and/or wearer-adapted features for an individual user or group of users could be incorporated.

### BACKGROUND OF THE INVENTION

There is a wide variety of designs for body protective equipment and related clothing currently available for individual wear. Although the specific features of body protective equipment are highly dependent upon the wearer and protective application(s), body protective equipment is typically designed (at least in part) to ameliorate, reduce and/or eliminate the traumatic effects of impacts between other objects and the wearer' body. Some body protective clothing may be designed to primarily protect the wearer from relatively slower velocity impacts between the wearer and stationary or moving objects (i.e., football or lacrosse pads), while other designs may seek to provide the wearer with protection from much higher velocity impacts, such as from fast moving smaller objects like such as bullets and shell fragments (i.e., bulletproof vests and combat body armor). Other protective clothing designs may primarily seek to protect the wearer primarily from pointed or edged objects such as knives and/or sharp fragments (i.e., stab or slash proof vests). In many cases, an individual item of protective clothing will be designed to provide varying degrees of protection against a variety of impact types and/or scenarios, with many “tradeoffs” made in design and/or level of protection to accommodate various factors including cost, weight, durability, comfort and/or wearability of the item.

Personal protective equipment plays an important role in maintaining the safety of athletes participating in various sports. The usage and development of protective gear in sports has evolved over time, and continues to advance. Many sports leagues and professional sports mandate the use of protective gear for athletes. Use of protective gear is also typically mandated in college athletics and occasionally in amateur sports.

One class of protective equipment used in sport is for the prevention of or protection from injury due to impact. Due to the nature of many sports, athletes may be impacted by other players, gear, or objects. These impacts can cause contusions, bruises, wounds, bone fractures, concussions or other head injuries, or spinal cord injuries. Impacts can also cause commotio cordis, a lethal disruption of heart rhythm that occurs as a result of a blow to the area directly over the precordial region of the heart.

In addition to athletic applications, body armor and other protective clothing is essential equipment for police and military personnel. Currently, body armor is primarily fielded in high-risk scenarios, and is typically limited to chest and head protection. However, a significant percentage of battlefield and law enforcement injuries occur to the groin and extremities, including the arms, legs, hands, and neck. Desirably, armor designs would also be available for these areas to offer protection from fragments and ballistic/non-ballistic threats.

Aside from weight constraints, one of the most significant limitations affecting body armor and other protective garment design is the desire for the protective clothing to be flexible in some or all of the garment, which optimally allows a wearer to move their extremities and/or body in a natural motion, desirably without significantly limiting the wearer's mobility and dexterity. This flexibility can be especially difficult to achieve in high-velocity protective garments, where the high-velocity protection against projectiles may be provided by large, rigid sheets (i.e., ballistic inserts). Even where high tensile strength penetration-resistant fabrics are used for vest or parts of vest, including graphite fibers, nylon fibers, ceramic fibers, polyethylene fibers, glass fibers, layers of aramid or polyaramid poly(phenylene diamine terephthalamide) fabrics (sold by DuPont under the registered name of Kevlar®) and the like, these fibers are typically formed into a woven or knitted fabric, and encapsulated or embedded in a matrix material, which renders them relatively stiff and less than flexible.

Moreover, in protective armors made from fiber materials, it is often difficult to limit the risk of serious injury to the user while at the same time designing an armor having low weight, reduced bulk and appreciable flexibility, because the fibers of the penetration-resistant fabric typically stretch as they absorb a bullet's energy—thereby creating a bulge at a back surface of the impact (i.e., a surface opposite the location impacted by the bullet). The bulge at the back surface can transmit an appreciable shock to an adjacent region of the user's body, with this bulge referred to as the “backface signature,” and the transmitted shock is called the “blunt trauma” experienced by the wearer. This can also be true of conventional body armor materials comprised of many metallic and/or ceramic tile inserts, as the arrangement of these materials is typically too bulky and/or stiff for applications to joint and/or extremity protection, and the backface signature of many of these materials may be substantial.

Although protective gear in sports and other areas has improved over time, there is a need for better protective equipment to protect athletes from impact related injuries. In a similar manner, a need exists for new protective garment designs that offer the equivalent or improved ballistic and/or other protective performances of existing protective clothing and/or body armor materials and/or designs, but with significantly more compactness and/or flexibility.

### BRIEF SUMMARY OF THE INVENTION

Current protective garment designs are limited in that relatively bulky and/or stiff layers of protective and/or cushioning materials are typically required to provide a sufficient level of impact absorption and/or distribution to protect a wearer against the effects of slow and/or high velocity impacts. These layers of material can be heavy, bulky and/or uncomfortable to wear, and existing designs may also fail to protect various body portions of the wearer (i.e., arms, legs, joints, neck and/or abdomen). In addition, some protective garments may actually cause additional injury to the wearer, including over-exertion, heat exhaustion, muscle pulls and strains, trips, falls and/or other injuries or maladies due to various balance and movement restrictions that the clothing may place on the wearer, which could include any pain, discomfort and/or tissue damage due to inadequate impact protection, weight, lack of adequate ventilation, lack of cushioning, and/or improper fit. To address many of these issues, protective garment designs are herein proposed that incorporate one or more impact absorbing structures (IAS) comprising filaments, columns and/or other buckling structures into arrays in a clothing layer or other garment element that can desirably absorb low and/or high velocity impacts, reduce garment weight and bulkiness, improve garment ventilation, alleviate garment imbalance and/or improve wearer movement and/or comfort, without significantly increasing the overall cost and/or durability of the garment.

In various embodiments, IAS arrays can be incorporated into components of a protective vest, chest/back protector and/or other garment, including into a surface layer, intermediate layer and/or under-layer of the garment. The use of buckling structures and associated IAS arrays in such applications can greatly facilitate the performance of impact absorbing structures in a relatively small, compact, flexible and lightweight footprint. Moreover, IAS arrays can be utilized to supplement and/or replace many existing cushioning or other structures in a protective garment, often without requiring significant redesign or alteration of many components of the existing garment configuration.

In various embodiments, the ability to “tune” the buckling response of filaments and columns in IAS arrays can greatly enhance the adaptability and/or utility of existing and/or improved protective garment designs, including the ability to modify the impact absorbing performance of a specific region or regions of the garment in a desired manner to accommodate the unique requirements of a specific activity, sport and/or athletic endeavor as well as the needs of the individuals wearing the garment. In various embodiments, a protective garment design and/or performance can be particularized to the specific needs of an individual and/or group of individuals (including differing responses to various impact “threats”), which could include protective garment designs that perform “differently” under similar loading during different circumstances, which could include the ability for a user to manually and/or automatically modify their protective garment response in a desired manner.

In various embodiment, the incorporation of IAS arrays and buckling structures can significantly enhance the durability of cushioning structures in protective garments, including reducing and/or eliminating component failure due to various environmental factors and increasing “shelf life” and/or limit or remove the need for degradable components. Properly designed, IAS arrays can also be much more durable than existing cushioning materials, and can incorporate localized variations in filament distribution and/or impact response that are difficult and/or expensive to accomplish using traditional materials. Moreover, IAS arrays and buckling structures can be designed and formed to accommodate and/or disperse water and/or sweat, can be washable and/or coatable and can be configured to greatly reduce the opportunity for mold, pollutants and/or other materials to invade and/or degrade the protective garment materials.

### BRIEF DESCRIPTION OF THE SEVERAL VIEWS OF THE DRAWINGS

The foregoing and other objects, aspects, features, and advantages of embodiments will become more apparent and may be better understood by referring to the following description, taken in conjunction with the accompanying drawings, in which:

FIGS. 1A and 1B show a front plan and perspective view of typical prior art protective garments or vests;

FIG. 2A depicts a front plan view of one embodiment of a protective garment or vest that incorporates a plurality of round, rigid impact plates or discs;

FIG. 2B depicts a front plan view of one alternative embodiment of a protective garment or vest that incorporates a plurality of hexagonal impact plates;

FIG. 3 depicts a cross section side view of one exemplary embodiment of a protective vest which includes a combination of layers to provide impact protection;

FIG. 4A depicts a perspective view of one exemplary embodiment of an Impact Absorbing Structure (IAS) array constructed in accordance with various teachings of the present invention;

FIG. 4B depicts a perspective view of an alternative embodiment of an IAS array;

FIG. 5 depicts another exemplary embodiment of an IAS array;

FIG. 6A depicts one potential response to an incident force of the exemplary IAS of FIG. 5;

FIGS. 6B and 6C depict various potential responses to varying impact forces on the exemplary IAS of FIG. 5;

FIG. 6D depicts another exemplary potential response of the IAS of FIG. 5 to an incident force F;

FIG. 6E depicts another alternative embodiment of an IAS constructed in accordance with various teachings of the present invention;

FIGS. 7A and 7B depict one exemplary embodiment of a composite IAS array having a plurality of individual plate elements;

FIG. 8 depicts another exemplary embodiment of a composite IAS array having a plurality of individual plate elements;

FIG. 9A depicts an exemplary matrix of generally cylindrical columns or filaments made from an elastic material, which could serve as part of an IAS matrix;

FIG. 9B depicts one alternative embodiment of an IAS matrix or filament bed, incorporating generally cylindrical columns of varying lengths and/or diameters;

FIG. 10 depicts a front plan view of the protective garment of FIG. 2A, showing various differing exemplary IAS array designs that accommodate differing peak pressure forces and/or force directions;

FIG. 11A depicts one embodiment of hexagonal filaments for use in an IAS matrix;

FIG. 11B depicts a filament bed incorporating a single face sheet and/or intermediate columnar projections;

FIG. 11C depicts a filament bed having an intermediate constraining structure or sheet;

FIG. 12A depicts an exemplary IAS array comprising a dense network of regularly and/or irregularly spaced smaller diameter columns;

FIG. 12B depicts another exemplary IAS array comprising a less-dense network of regularly and/or irregularly spaced larger diameter columns;

FIG. 12C depicts another exemplary IAS array comprising a network of elongate and/or irregularly-shaped filaments;

FIG. 12D depicts another exemplary IAS array comprising a network of angled filaments;

FIG. 12E depicts another exemplary IAS array comprising a network of opposing or crossing angle filaments;

FIGS. 13A through 13I depict various alternative embodiments of exemplary IAS filament arrays, including embodiments comprising a variety of filament designs, arrangements, shapes, sizes, cross-sections, distributions, materials and/or configurations;

FIGS. 14A through 14D depict cross-sectional views of various exemplary embodiments of IAS configurations potentially useful in addressing impact forces;

FIGS. 15A through 15D depict cross-sectional view of various exemplary layers incorporating IAS arrays;

FIGS. 16A through 16I depict various alternative embodiments of exemplary IAS and array configurations, including IAS designs and/or arrays that can be incorporated into various protective garments;

FIGS. 17A and 17B depict one exemplary embodiment of upper and lower IAS components that can be combined together to form a composite IAS array;

FIG. 17C depicts an exemplary technique for assembling a composite IAS array;

FIG. 17D depicts an exemplary combined element of a composite IAS array;

FIGS. 18A through 18C depict alternative embodiments of upper components for a composite IAS array, wherein each upper component could alter the performance of the combined IAS array;

FIGS. 19A through 19C depict various exemplary embodiments of boundary and/or internals walls or other structures that can form a portion of the IAS array or IAS array containment feature, and/or which can assist an IAS array with absorbing and/or otherwise resisting non-axial, rotational, lateral and/or other loading of the filament array;

FIGS. 20A through 20C depict exemplary sheets, tension bands and/or compression bands that can be incorporated into the filaments of IAS arrays to desirably alter the impact absorption and/or buckling performance of some or all of the filaments therein;

FIG. 20D depicts an alternative embodiment of a constraining system for constraining and/or controlling the buckling response of some or all of the filaments in an IAS array in a desired manner;

FIGS. 21A through 21C show perspective views of impact absorbing structures comprising connected support members, in accordance with various alternative embodiments;

FIGS. 22 through 24 show example structural groups including multiple support members positioned relative to each other with different support members coupled to each other by connecting members, in accordance with various alternative embodiments;

FIG. 25A depicts another exemplary embodiment of an improved impact absorbing element comprising a plurality of filaments interconnected by laterally positioned walls or sheets in a hexagonal configuration;

FIG. 25B depicts an alternative embodiment of an improved hexagonal impact absorbing element, with differing sized walls between filaments;

FIG. 25C depicts another alternative embodiment of an improved hexagonal impact absorbing element, with non-symmetrical arrangement of the filaments and walls;

FIG. 26A depicts a side view of a portion of an array element, showing an exemplary pair of filaments connected by a lateral wall and lower face sheet;

FIG. 26B depicts a top plan view of the array element portion of FIG. 22A with some exemplary buckling constraints identified;

FIG. 26C depicts a top plan view of an exemplary hexagonal element with some exemplary buckling constraints identified;

FIG. 26D depicts a perspective view of another embodiment of a hexagonal impact absorbing element, with an exemplary potential mechanical behavior of one filament element undergoing progressive buckling depicted in a simplified format;

FIG. 27A depicts alternative embodiments of hexagonal elements incorporating thinner or thicker filament diameters;

FIG. 27B depicts a cross-sectional portion of an exemplary hexagonal element, identifying some of the structural features, alignments and/or dimensions that could be altered to tune or tailor the element to a desired performance;

FIG. 28 depicts a top plan view of another embodiment of a hexagonal impact absorbing element incorporating lateral walls of differing thicknesses in the same element

FIG. 29A depicts a perspective view of one embodiment of an impact absorbing array incorporating closed polygonal elements, including hexagonal elements and square elements;

FIG. 29B is a simplified top plan view of the impact absorbing array and lower face sheet of FIG. 29A;

FIG. 29C is a bottom perspective view of the pierced lower face sheet and associated impact absorbing array of FIG. 29A;

FIG. 30A depicts an alternative embodiment of an impact absorbing array comprising a plurality of hexagonal elements in a generally repeating symmetrical arrangement;

FIG. 30B depicts how elements of the impact absorbing array of FIG. 30A can be redistributed to accommodate bending of the lower face sheet;

FIG. 31A depicts a perspective view of another alternative embodiment of a hexagonal impact absorbing element which incorporates an upper ridge feature;

FIG. 31B depicts a cross-sectional view of the hexagonal impact absorbing element of FIG. 31A;

FIG. 32A depicts an engagement insert, grommet or plug for insertion into the hexagonal element of FIG. 31A.

FIG. 32B depicts the insert of FIG. 32A engaged with the hexagonal element of FIG. 31A;

FIGS. 32C and 32D depict various alternative embodiments of impact absorbing arrays incorporating hexagonal elements with integral engagement features;

FIG. 33 depicts a top perspective views of another alternative embodiment of an impact absorbing array; and

FIGS. 34A and 34B depict perspective and cross-sectional side views of one exemplary embodiment of a floating impact element for use with various of the IAS arrays described herein.

### DETAILED DESCRIPTION OF THE INVENTION

In various embodiments, a protective garment is disclosed that includes an outer layer, an intermediate or reflex layer and an inner layer. The outer layer can comprise one or more relatively rigid components, sheets and/or plates, or can comprise a layered construct of one or more flexible and/or semi-flexible components. The inner layer can comprise one or more relatively rigid components, sheets and/or plates, or can comprise a layer construct of one or more flexible and/or semi-flexible components. The inner layer desirably is the structure which contacts the wearer and the outer layer is the structure facing towards the impacting item. In between these two structures, various impact absorbing materials, impact absorbing structures, or combinations of impact absorbing materials and impact absorbing structures may be placed to increase comfort for the wearer and reduce the transmission of impact forces to the wearer's anatomy. Hereinafter, these impact absorbing material and structures are collectively referred to as IAS.

It is believed that the weight, flexibility, peak impact loads and/or loading directions/responses provided by current protective garment designs is suboptimal, in that current protective garment designs do not provide sufficient impact protection for a variety of conditions in a durable, light, flexible garment. To address these various issues with current designs, it is proposed that one or more IAS matrices and/or layers can be positioned in between the outer and inner layers of a protective garment and can incorporate sufficient strength and structural integrity to resist, delay and/or redirect forces from a variety of high and/or low velocity impacts. Additionally, the structures within the IAS array may undergo deformation (e.g., buckling) when subjected to forces from a sufficiently strong impact force. As a result of the structure design, arrangement and performance, including deformation and buckling, the IAS array(s) desirably reduces peak energy transmitted from the outer layer to the inner layer, and thereby moderates, reduces and/or redirects the various forces transmitted to the wearer's torso and/or other anatomy. In various embodiments, the IAS matrix may provide significant flexibility to various components of the protective garment and/or allow portions of the protective garment to move independently from other portions in a variety of planes or directions.

In this manner and others, the IAS desirably may reduce the incidence and severity of impact as a result of sports and other activities. The various embodiments described herein will often have equal utility for the protection of athletes and other individuals. Impact related injuries occur commonly in contact sports such as ice hockey, football, rugby, lacrosse, and soccer because of the dynamic and high collision nature of these sports. Collisions with the ground, objects, gear, and other players are common. Injuries from impact can include:
Contusions or bruises—damage to small blood vessels which causes bleeding within the tissues
Wounds—abrasion or puncture of the skin
Bone fractures—break(s) in the bone
Head injuries—concussions, traumatic brain injury, or chronic traumatic encephalopathy (CTE)
Spinal cord injuries—damage to the central nervous system or spine
Other impact related injuries such as commotio cordis

Commotio cordis is an often lethal disruption of heart rhythm that occurs as a result of a blow to the area directly over the precordial region of the heart at a critical time during the cycle of a heart beat causing cardiac arrest. It is a form of ventricular fibrillation, not mechanical damage to the heart muscle or surrounding organs, and not the result of heart disease. The fatality rate has been reported to be approximately 65%. It can sometimes, but not always, be reversed by defibrillation. It occurs mostly in boys and young men (average age 15), usually during sports, often despite a chest protector. It is most often caused by a projectile, but can also be caused by the blow of an elbow or other body part. Being less developed, the thorax of an adolescent is likely more prone to this injury. Commotio cordis is a very rare event, and some of the sports which have a risk for this cause of trauma are baseball, football, ice hockey, polo, rugby, cricket, softball, fencing, lacrosse, boxing, karate, kung fu, and other martial arts.

There are many types of protective equipment used in sports for the prevention of or protection from injury due to impact. These differ from sport to sport, and may include, but are not limited to:
Helmets
Rib protectors
Shoulder pads
Protective cups
Hip pads
Tailbone pads
Thigh pads
Knee pads
Elbow pads
Arm pads
Wrist pads
Chest protectors
Gloves
Shin guards
Neck or throat guards
Hockey pants which incorporate thigh, pelvic, hip and tailbone pads

Protective equipment for the body of athletes is generally constructed by attaching some type or protective (i.e., impact attenuating} pad or structure to an article of clothing or some type of elastic, neoprene, or fabric sleeve which holds the pad in place over the area of the body intended for protection. For example, to protect from commotio cordis, the protective structure would desirably be secured on the thorax directly over the precordial region of the heart. Currently marketed athletic gear for protecting athletes from impact related injury is not optimal, as a large number of impact related injuries still occur in athletic competition and play. The design of these products could be enhanced by improving the impact attenuating characteristics of the protective portion(s) of the product.

The various aspects and features of the embodiments disclosed herein are intended to apply to all structures used to protect various portions of the human and/or animal anatomy (including, but not limited to, military and civilian service dogs) from impact and/or injury.

In various embodiments, body protective equipment includes a protective portion and an attachment portion. The protective portion protects the body from impact and the attachment portion holds the protective portion over or on the area of the body to be protected. The attachment portion may consist of an article of clothing having a pocket for mounting of the protective portion and/or it may consist of some type of elastic, neoprene, or fabric sleeve which holds the protective portion to the area of the body to be protected. Other attachment means such as laces, Velcro straps, or straps with buckles may also be used.

The protective portion generally includes a body facing surface and an outward facing surface, between which is the impact attenuating material or structure. The impact attenuating material or structure may consist of various impact absorbing materials, impact absorbing structures, or combinations of impact absorbing materials and impact absorbing structures, and may be placed to increase comfort for the wearer and reduce the transmission of impact forces to the body. In various embodiments, the body facing surface of the protective portion may be somewhat rigid to serve as a stable platform for the wearer or to potentially spread impact forces over a wider area of the impact, or it may be more flexible for comfort. The outward facing surface may also be somewhat rigid to increase protection from sharp objects or it may be more flexible or conformable to provide better impact absorption.

An IAS which is positioned in between the body facing and outward facing surfaces (or which may be integral with each of these surfaces) will desirably have sufficient strength to resist forces from the impacts typically encountered in athletic sports. Additionally, the structures within the IAS may undergo deformation (e.g. buckling} when subjected to forces from a sufficiently strong impact force. A s a result of the deformation, the IAS reduces energy transmitted from the outward facing surface to the body facing surface, thereby reducing impact forces transmitted to the wearer's body. The IAS may also allow the outward facing surface to move independently of the body facing surface in a variety of planes or directions. Thus, the IAS reduces the incidence and severity of impact as a result of sports and other activities.

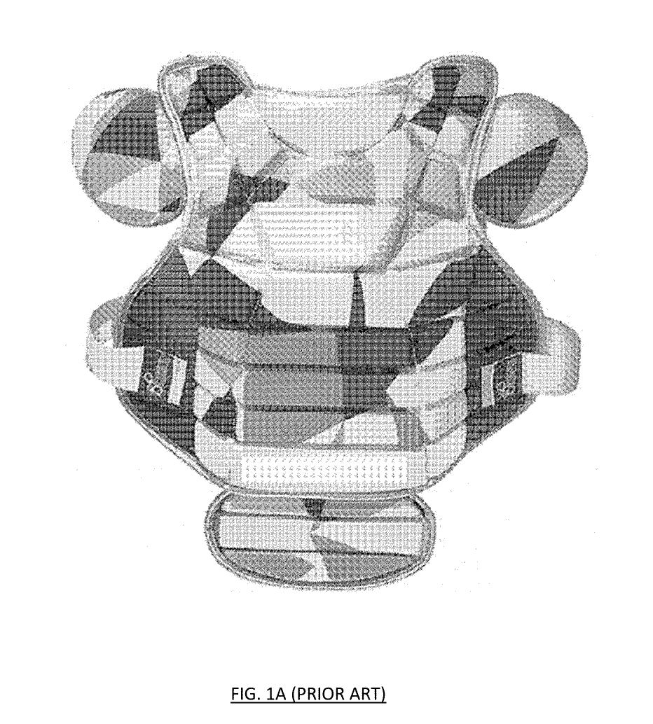

FIG. 1A shows a typical prior art chest protector. In this figure, each of the raised, cushioned areas is typically filled with impact absorbing materials and/or structures such as foam or air. In various embodiments, one or more of these areas could be replaced with any of the protective structures described herein, which could be placed in between the body facing surface and outward facing surface of the garment, either as described or in combination with other materials or structures. In general, IAS structures may be made of foams, elastomers, polymers, or metals, which can compress or buckle to reduce impact forces. Although not shown in all cases, layers of foam (open cell, closed cell, memory foam, typical fluids, or non-newtonian fluids) may be layered in or among the IAS to provide cushioning, impact absorption, stability, and rigidity as needed to protect the wearer during athletic activity.

FIG. 1B shows a perspective view of a prior art ballistic protection apparatus comprising an impact resistant jacket or vest 10. In this embodiment, the vest 10 includes a chest portion 20, a back portion 30 and side panels 40 and 50 at the edges of the chest and back portions. The chest and back portions are connected by a pair of shoulder straps 60 and 70 extending over the shoulders of a wearer (not shown), and by one or more waist belt straps 80 and 90 encircling the lower torso (not shown) of the wearer.

The vest 10 can include a variety or cushioning and/or impact absorbing materials and/or layers, and such vests typically include multiple layers of a Kevlar or similar fabric weave to absorb high velocity impacts, which can make the vest heavy and bulky. Some vest designs rely further upon thick metal and/or ceramic plate inserts to protect vital organs against higher-powered weapons, which can add considerable weight to the vest and can also greatly limit the flexibility of the vest as well as the mobility and agility of the user.

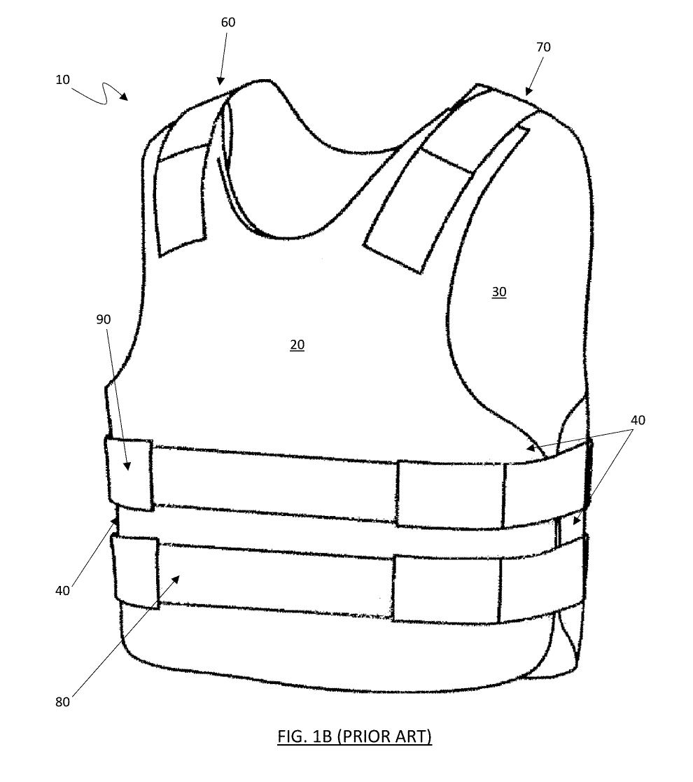

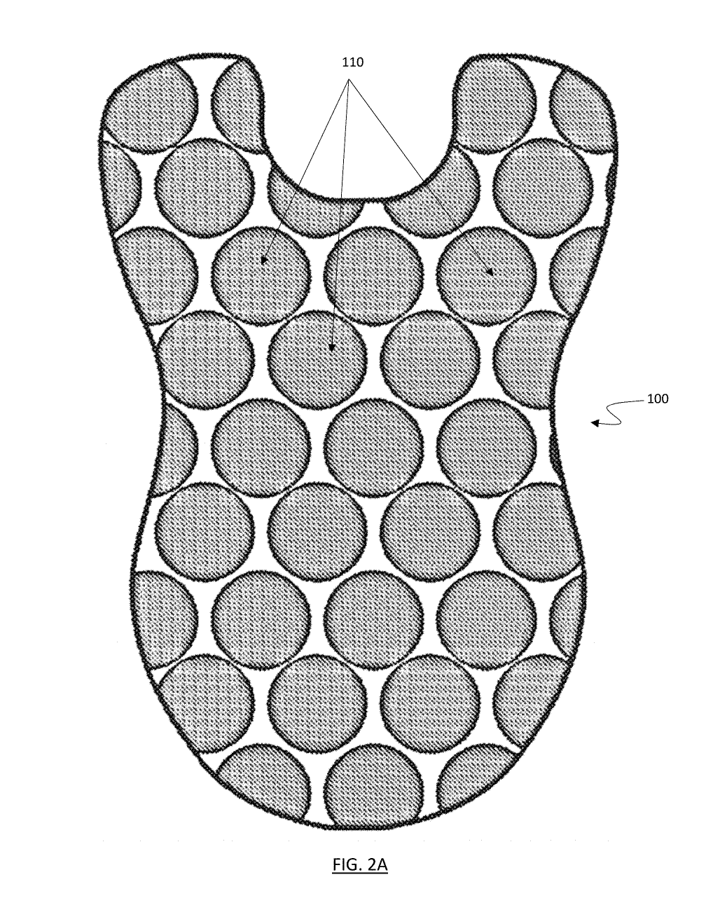

FIG. 2A shows a front plan view of one embodiment of a protective garment or vest 100 which incorporates a plurality of rigid plates or discs 110 in the vest. As depicted, the discs 110 can be positioned on an outer surface of the vest, or they may be positioned within a layer between the outer and/or inner surfaces of the vest, or in some embodiments may be positioned on an inner surface of the vest. The discs may be set in a regular or irregular pattern, and each disc may be positioned adjacent to other discs and/or may be imbricated (i.e., overlapping) with one or more adjacent discs. FIG. 2A depicts rounded or oval discs 110, while FIG. 2B depicts hexagonal discs 120. In various embodiments, portions of discs (i.e., a half-circle disc) may also be incorporated into various locations of the vest to accommodate wearer anatomy and/or design constraints.

In various embodiments, an outer solid layer that distributes the point impact load to a larger surface of the IAS array may be made of multiple pieces that are nested or grouped together to allow for the protective product to flex and take shape with the user. FIGS. 2A and 2B are just two examples of how the solid layer maybe made of multiple pieces within the system. These pieces could be any shape and may not be repeating the same shape as they may be designed to allow for more or less flexibility in different areas of the product. These pieces may also overlap and/or not necessarily be spaced uniformly.

Each of the discs 110 and 120 can be formed of a high hardness material. In various embodiments, an overlap of the imbricated placement pattern can be effective to spread the force of a high velocity projectile hit to adjacent disks, thereby preventing and/or reducing penetration and backside deformation. Additionally, if desired a slight tilt can be provided on an outward face of each overlapping disk in the imbricated pattern, wherein some of the impact energy of a surface strike can be absorbed into deflection of other adjacent disks. In one exemplary embodiment a series of titanium disks one to 2 inches in diameter and having a generally uniform thickness in the range of 0.032 to 0.050 inches in thickness can be used to form the imbricated pattern. In alternative embodiments, disks of metal or ceramic having a discus or other shapes may be employed.

Many modern protective garments such as bullet resistant vests typically include high tensile strength ballistic material layers. Some high tensile strength ballistic resistant materials will tend to deform and slow down a high velocity projectile, while other types of high tensile strength ballistic materials tend to grab and turn a ballistic projectile. Grabbing and turning the ballistic projectile will introduce yaw into the path of the ballistic projectile. Yaw is a pivoting motion perpendicular to the direction the projectile is traveling. A fragment projectile undergoing yaw will either roll onto its side or tumble. As the fragment projectile rolls or tumbles more surface area is exposed to be caught by the vest.

The tensile strength of a ballistic fabric is a leading indicator of that fabric's ability to induce yaw into the path of a projectile. A higher tensile strength gives the fabric a better ability to grab the projectile before yield than a lower tensile strength fabric. The fabric's “grabbing” of the projectile before yielding is what induces yaw into the path of the projectile. The tensile strength of a thread of ballistic material can be increased by increasing the denier of the thread. Thus a 1500 denier material will have a higher tensile strength than an 800 denier material of an identical fiber.

The behavior of high tensile strength ballistic resistant material is the result of the material's tensile strength, elongation to failure and pick count. When struck by a ballistic projectile, a high tensile strength ballistic material with a high pick count and a low elongation to failure will tend to grab at a projectile and turn it to induce yaw, but will not cause much deformation or slowing of the projectile. A ballistic material with a higher elongation to failure will tend to hang on to the projectile relatively longer deforming the projectile and slowing it down before yielding and allowing the projectile to pass through the material. Thus, similar materials with differing pick count and deniers may effectively make different performing fabrics. While materials with similar deniers and similar pick counts might be thought to have identical stopping power and abilities, a varying elongation to failure could make these materials completely dissimilar. Thus, it is not always possible to base exact ratios of equal projectile stopping ability based on only denier and pick counts.

In various embodiments, various lay-ups of Kevlar® KM2 1500 and Twaron® 840 denier fabrics may be utilized. One of ordinary skill in the art would however recognize, that with adequate notice taken to denier, pick count and elongation to failure various materials can be substituted for the Kevlar® KM2 1500 and Twaron® 840 material mentioned above. Such substitutions can be, but are not limited to para aramids such as PBO Zylon®, various denier Kevlar® KM2 derivative materials such as 800 denier, 600 denier, or 400 denier material and Kevlar® 129 400 denier material.

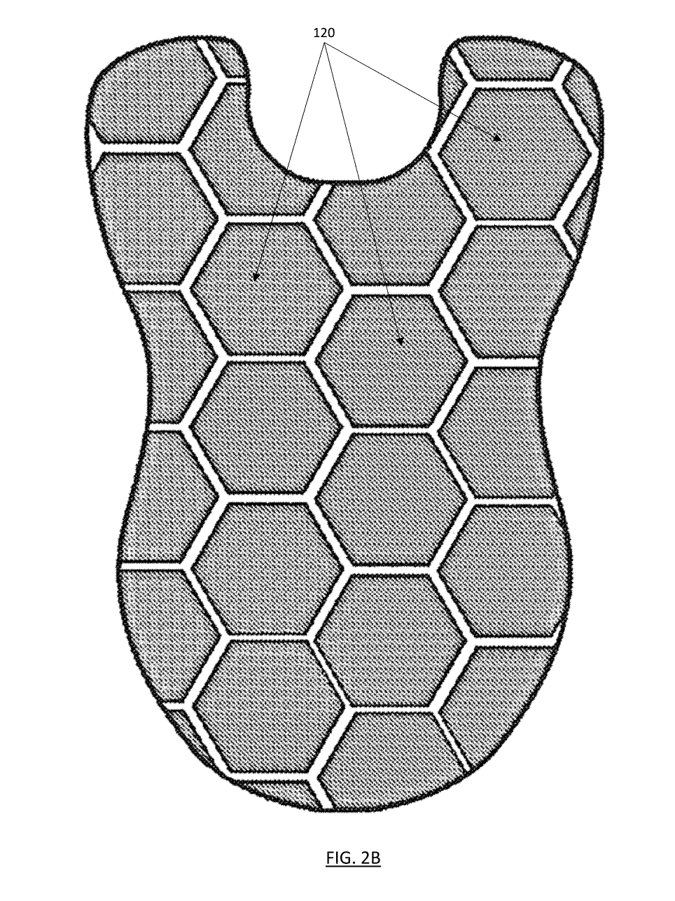

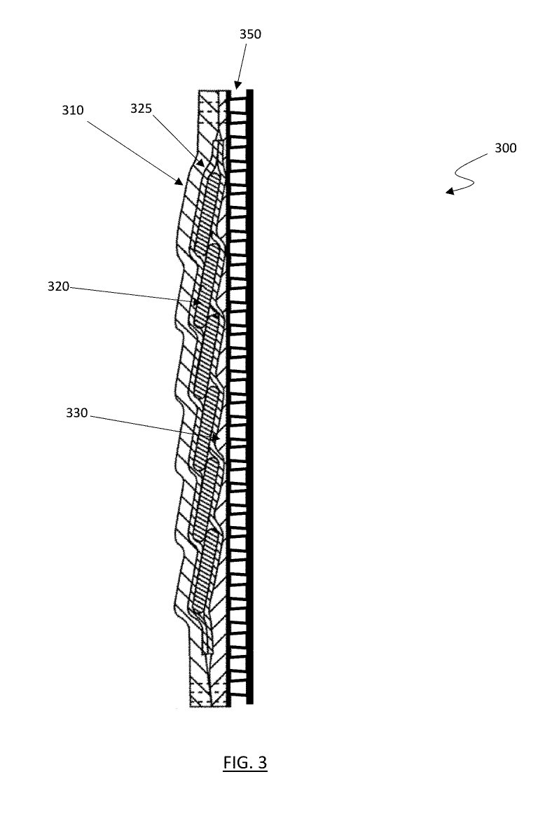

FIG. 3 depicts a cross section side view of one exemplary embodiment of a protective vest 300, which includes a combination of layers designed to ultimately cause deformation to a fragment and to induce yaw into the fragment. The first layer 310 of the vest is a high tensile strength ballistic fiber. In one embodiment, the first layer can be one ply of Twaron® 840 denier aramid fabric (commercially available from Akzo Nobel Twaron, Inc. of Arnhem of the Netherlands) with a pick count of 27×27. Twaron® at this denier and pick count has an areal density of 0.67 oz. per square foot. This high tensile strength ballistic fabric layer can have an imbricated pattern of high hardness disks 320 (similar to those described in FIGS. 2A and 2B). If desired, an adhesive 325 can be used to adhere the disks in an imbricated pattern to the ballistic fabric, including using a petroleum based low modulus adhesives available from Bondtex Inc., Los Angeles, Calif. A second layer 330 of ballistic grade fabric can then be provided, if desired. Desirably the combination of the two layers of ballistic grade fabric and imbricated discs (collectively the “ballistic layer”) will slow and/or deform the high velocity fragment projectile to a significant degree. In at least one alternative embodiment the second layer of ballistic grade fabric can also be one ply of Twaron® 840 denier with a pick count of 27×27, which has been found effective in slowing and deforming projectiles.

Adjacent to and below the ballistic layer, an impact absorbing structure (IAS) 350 can provided. In various embodiment, the IAS can comprise one or more arrays of longitudinally-extending vertical filaments, columns and/or other buckling structures attached to at least one face sheet. In use, the IAS layer(s) will desirably ameliorate, reduce and/or prevent any backside deformation and/or “signature” from the ballistic layer (induced by the impact of the high velocity projectile) from extruding a significant distance beyond the face sheet. In addition, the IAS will desirably provide a deformable or “soft backing” for various components of the ballistic layer, which may improve the ballistic performance of the vest and prevent premature component failure. to

In at least one exemplary embodiment, the IAS may comprise one or more arrays of longitudinally-extending vertical filaments, columns and/or other buckling structures attached to at least one face sheet, with each vertical filament incorporating a wall, web or thin sheet of material extending laterally to at least one adjacent filament. In various embodiments, the extending lateral walls can be thinner than the diameter of the vertical filaments, with the lateral walls desirably acting as reinforcing members and/or “lateral buckling sheets” that can inhibit buckling, bending and/or other deformation of some portion of the vertical filaments in one or more desired manners. By incorporating lateral walls between the vertical filaments of the impact absorbing array, the individual vertical filaments can potentially be reduced in diameter and/or spaced further apart to create an impact absorbing array of laterally reinforced vertical filaments having an equivalent compressive response to that of a larger diameter and/or higher density array of unsupported vertical filaments. Moreover, in various embodiments the response of the array to lateral and/or torsional loading can be effectively “uncoupled” from its axial loading response to varying degrees, with the axial loading response primarily dependent upon the diameter, density and/or spacing of the vertical filaments in the array and the lateral/torsional loading response dependent upon the orientation, location and/or thicknesses of the lateral walls.

In various exemplary embodiments, the IAS can incorporate an array of vertically oriented filaments incorporating lateral walls positioned in a “repeated polygon” structural element configuration, in which the lateral walls between filaments are primarily arranged to extend in repeating geometric patterns, such as triangles, squares, pentagons, hexagons, septagons, octagons, nonagons and/or decagons. In various other embodiments, the lateral walls may be arranged in one or more repeated geometric configurations, such as parallel or converging/diverging lines, crisscrossing figures, cross-hatches, plus signs, curved lines, asterisks, etc. In other embodiments, various combinations thereof, including non-repeated configurations and/or outlier connections in repeating arrays (i.e., including connections to filaments at the edge of an impact absorbing array or filament bed) can be utilized.

In one exemplary embodiment, an impact absorbing structure can be created wherein filaments in the vertically orientated filament array are connected by lateral walls positioned in a hexagonal polygonal configuration. In one exemplary embodiment, each filament can be connected by lateral walls to two adjacent filaments, with an approximately 120-degree separation angle between the two lateral walls connecting to each filament, leading to a surprisingly stable array configuration that can optionally obviate the need and/or desire for a second face sheet proximate to an upper end of the filaments of the array. The absence of a second face sheet on the array can desirably greatly facilitate manufacture of the array using a variety of manufacturing methods, including low-cost and/or high throughout manufacture by injection molding, compression molding, transfer molding, thermoforming, blow molding and/or vacuum forming. If desired, the first face sheet (i.e., the lower face sheet) can be pierced, holed, webbed, latticed and/or otherwise perforated, which may further reduce weight and/or material density of the face sheet (and weight/density of the overall array) as well as facilitate bending, curving, shaping and/or other flexibility of the array at room temperatures to accommodate curved, spherical and/or irregularly shaped regions such as the curved exterior of the wearer's chest and/or within flexible clothing. Such flexible arrays can also reduce manufacturing costs, as they can be manufactured in large quantities in a flat-plane configuration and then subsequently cut and bent or otherwise shaped into a wide variety of desired shapes.

The incorporation of lateral walls in the filament bed, which can desirably allow a commensurate reduction in the diameter of the filaments and/or an as increased filament spacing, can also greatly reduce the height at which the array will “bottom out” under compressive and/or axial loading, which can occur when the filament columns of the array have completely buckled and/or collapsed (i.e., the array is “fully compressed”), and the collapsed filament material and bent wall materials can fold and “pile up” to form a relatively solid layer of material resisting further compressive loading. As compared to an impact absorbing array of conventional columnar filament design, an improved impact absorbing array incorporating lateral walls can be reduced to half as tall (i.e., 50% of the offset) as the conventional array, yet provide the same or equivalent impact absorbing performance, including providing an equivalent total amount of layer deflection to that allowed by the conventional filament array. Specifically, where a traditional 1 inch tall filament column array may compress ½ inch before “bottoming out” (as the filament bed becomes fully compressed at 0.5 inches height), one exemplary embodiment of an improved filament array incorporating lateral wall support that is 0.7 inches tall can compress ½ inch before bottoming out (as the filament bed becomes fully compressed at 0.25 inches height). This arrangement provides for equivalent and/or improved axial array performance in a reduced profile or “offset” as compared to the traditional filament array design.

In various embodiments, an improved impact absorbing array can incorporate various “draft” or tapered features, which can facilitate removal of the filaments and wall structures from an injection mold or other manufacturing equipment as well as potentially improve the performance of the array. In one exemplary embodiment incorporating a hexagonal wall/filament configuration, the outer and inner walls of the hexagonal elements (and/or the outer and inner walls of the filaments) may be slightly canted and/or tapered to facilitate ejection of the array from the mold. In various embodiments, the walls and/or filaments will desirably include at least 0.5 degrees of draft on all vertical faces, which may more desirably be increased to 2 to 3 degrees or greater for various components.

In various embodiments, the improved impact absorbing structures may be customized and retrofitted into one or more commercially available protective garments and/or other protective clothing. Various specifications (e.g., mechanical characteristics, behavioral characteristics, the configuration profile, fit and/or aesthetics) can be provided to customize or semi-customize the impact absorbing structures. If desired, an original liner and/or material layers can be removed from an existing protective garment and/or protective item, and can be replaced with the customized impact absorbing structures described herein.

In various embodiments, an existing ballistic trauma plate can include one or more flat or curved inner surfaces, wherein an improved impact absorbing structure can be attached and/or otherwise positioned proximate to an inner surface of the plate. In this manner, the trauma plate and attached IAS can be removed and/or replaced in the protective armor, which could include the use of different IAS arrays for different plate designs, different protective levels and/or anticipated environmental conditions.

In various embodiments, improved impact absorbing structures can be positioned within protective garment layers and desirably have sufficient strength to resist forces from mild collisions. However, the impact absorbing structures will also desirably undergo deformation (e.g., buckling) when subjected to forces from a sufficiently strong impact force such as a higher velocity projectile. As a result of this deformation, the impact absorbing structures desirably attenuate and/or reduce the peak force transmitted from the outer ballistic protection layers to and/or through the inner garment surfaces, thereby desirably reducing forces on the wearer's anatomy. The impact absorbing structures will also desirably allow various components of the ballistic outer layer to move independently of the inner garment layers in a variety of planes or directions. Thus, impact absorbing structures can greatly reduce the incidence and severity of impact injuries or other injuries as a result of high and low velocity impacts.

The impact absorbing structures may further include improved impact absorbing members physically or mechanically secured between multiple outer shell (i.e., ballistic layer) components and the inner layers of the garment, and/or between the outer shell components and inner garment layers in contact with the clothes or the body surface of the wearer. In one exemplary embodiment, an improved impact absorbing member can comprise an array of columns having one end secured to an inner face sheet (which can optionally be adjacent to the wearer's skin and/or clothing), with multiple laterally supporting walls extending between adjacent columns, with outer ends of the columns directly attached and/or formed around multiple ballistic discs or “coins,” with the multiple discs layers in an imbricated pattern and optionally movable with respect to each other.

In various embodiments, an improved impact absorbing member can include a plurality of vertical filaments joined by connecting walls or sheets to form a branched, closed and/or open polygonal shape, or various combinations thereof in a single array. By varying the length, width, and attachment angles of the filaments, the axial impact performance can desirably be altered, while varying the length, width, and attachment angles of the walls or sheets can desirably alter the lateral and/or torsional impact performance of the array. In various embodiments, the garment manufacturer can control the threshold amounts and/or directions of force that results in filament/wall deformation and ultimately garment protective performance.

In various embodiments, the IAS may comprise a plurality of modular components and/or rows to facilitate manufacturing. A modular row can include an inner surface, an optional outer surface, and one or more impact absorbing structures positioned therebetween (or thereon). A modular row can be relatively thin and/or flat compared to the assembled garment, which may reduce the complexity of forming the impact absorbing structures between inner and/or outer surfaces. For example, the modular rows may be formed by injection molding, extrusions, fusible core injection molding, or a lost wax process, techniques which may not be feasible for molding the entire impact absorbing structures in its final form. When assembled, the inner surfaces of the modular rows may form part an inner garment surface, and the outer surfaces of the modular rows may form part of an outer surface garment and/or ballistic element projectile engagement surface.

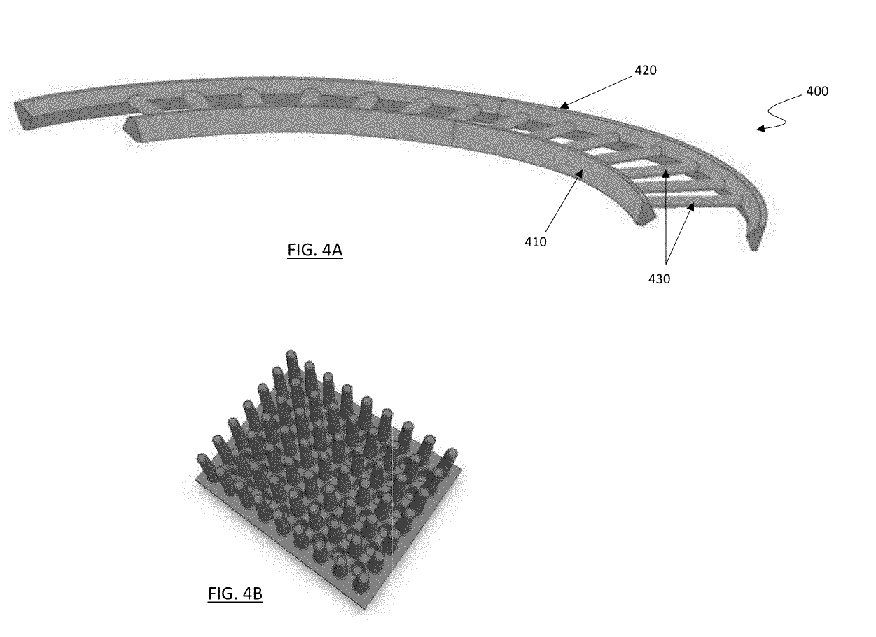

FIG. 4A depicts a perspective view of one exemplary embodiment of an impact absorbing structure 400 comprising an inner surface 410, an outer surface 420 and a series of impact absorbing structures 430 therebetween, which are depicted as filaments or columns in this figure. While depicted as a single row of filaments, the IAS array may similarly comprise a two or three dimensional “field” of such elements (See FIG. 4B), between an upper and lower face sheet, as well as a series of modular rows that may together define one or more sections of the IAS. In various embodiments, the row may further include a protective layer or other substance (e.g., foam and/or a thixotropic solid and/or liquid) that is more and/or less rigid than the impact absorbing structures, that encloses a remaining volume between the inner surface and outer surface after formation of the impact absorbing structures. Depending upon the application and/or environment of use, the end surfaces of the filaments may be parallel to each other and/or angled relative to each other, and the lower and optional upper face sheets may be perpendicular, parallel and/or tilted.

As illustrated, the impact absorbing structures 430 are columnar impact absorbing members which can be mechanically secured to both inner and outer surfaces 410 and 420 (which in this embodiment are depicted as concentric curved surfaces). An inner end of the impact absorbing structure may be mechanically secured to the inner surface 410 as a result of integral formation, by a fastener, by an adhesive, by an interlocking end portion (e.g., a press fit), another technique, or a combination thereof. The ends of the impact absorbing member can be secured perpendicularly to the local plane of the concentric surface 103 in order to maximize resistance to normal force, and/or one or more of the impact absorbing members may be secured at another angle to modify the resistance to normal force or to improve resistance to torque due to friction between an object and the outermost surface of the assembly. For a vertical impacting force, the magnitude of a critical incident force necessary to buckle a given impact absorbing member may increase with the diameter of the impact absorbing member, and may also decrease with the length of the impact absorbing member.

In various embodiments, an impact absorbing member can comprise a circular cross section, which may desirably simplify manufacture and/or can reduce and/or eliminate a significant number of stress concentrations occurring along edges of the structure, but other cross-sectional shapes (e.g., squares, hexagons) may be employed to alter manufacturability and/or modify performance characteristics. Generally, an impact absorbing structure will be formed from a compliant, yet strong material such as an elastomeric substrate such as hard durometer plastic (e.g., polyurethane, silicone) and may include a core and/or outer surface of a softer material such as open or closed-cell foam (e.g., polyurethane, polystyrene) or may be in contact with a fluid or gas (e.g., air). After forming the impact absorbing members, a remaining volume between the concentric surfaces (that is not filled by the impact absorbing members) may be left unfilled and/or may be filled with a softer material, such as foam, gel, fluid or gas (e.g., air).

IAS and Other Buckling Structures

Various aspects of the present invention include the realization of a need for various types of IAS and/or macroscopic support structures for replacing and/or augmenting various components and/or portions thereof in impact protective clothing and/or other garments, including in military and athletic equipment. In various embodiments, the incorporation of macroscopic support structures such as buckling structures can significantly increase the performance of existing protective and/or cushioning materials in a desirable manner, as well as enable and/or facilitate the use of materials in garment design that were heretofore useless, suboptimal and/or marginally useful in standard designs. For example, macroscopic buckling structures or IAS's can potentially enable the use of metallic columns and/or foamed metals (including 3D “printed” constructs of various materials) in the creation of soft, flexible layers having incredible strength and durability at a reasonable cost, which was heretofore impossible to accomplish. In effect, the compressive response and rebound behavior of many existing materials can desirably be “tuned” (using buckling structures and IAS arrays as described herein) to almost ANY response, as desired (using various combinations of structure forms, sizes, shapes, distributions and/or materials, for example). This arrangement greatly enhances the use of old materials in new applications for which they may have been unsuitable. As another example, one or more properly designed and/or positioned IAS arrays and/or buckling structures can be formed from natural and/or artificial rubbers or similar materials, which can provide an extremely durable cushioning and/or impact absorbing structure with a similar response and expense of polyurethane foam, if desired.

In various embodiment, IAS arrays can be specifically designed to resist impact forces in a desired manner, with the buckling structures incorporated into various garment components, such as in one or more layers of a protective garment. If desired, such structures could provide linear and/or non-linear resistances to loads and/or impact forces, including the ability to resist impact forces in a non-Newtonian manner, when desired. Moreover, various designs of macroscopic buckling structures can allow for customizing, tuning and/or modification (i.e., manual, automatic and/or various combinations thereof) of the impact resistance and performance criteria of individual buckling structures, including altering the performance of a single garment for a variety of different conditions, wearers and/or impact responses.

In various embodiments, one or more filament layers can be provided for impact absorption in various locations of the garment, such as across the chest or thorax, proximate to the neck or head, across the abdomen, waist and/or back, and/or around the arms or legs, with the filament layer(s) including a plurality of buckling structures configured to deform non-linearly in response to an incident force.

In various of the figures that follow, the structures and/or materials described may be placed in between an outer garment layer and the wearer's skin, either as described or in combination with other materials or structures. In general, the various described structures may be made of foams, elastomers, polymers, rubbers and/or metals, which in a proper configuration can compress and/or buckle in a predetermined manner to desirably reduce impact forces, reduce peak loading, better distribute forces across larger areas of the body and/or provide for improved “rebound” and garment performance. Although not shown in all cases, layers of foam or other materials (i.e., open cell, closed cell, memory foam, or non-Newtonian fluids) might be layered in or among the IAS matrices to provide cushioning, impact absorption, stability, preferred “failure” zones, directions or areas, and/or rigidity as needed during a variety of activities.

It should be understood that the various IAS matrices and structures described herein could have equal or greater utility in a variety of garment types and/or locations, and the use of such buckling structures in various garment components is specifically contemplated herein. For example, IAS or similar structures might be particularly useful when incorporated into the chest, back and/or extremities of the wearer, including the use of rate sensitive and/or non-Newtonian fluids to provide high-impact protection for sensitive anatomy while concurrently allowing for flexibility of those or other regions of the garment during normal movement of the wearer.

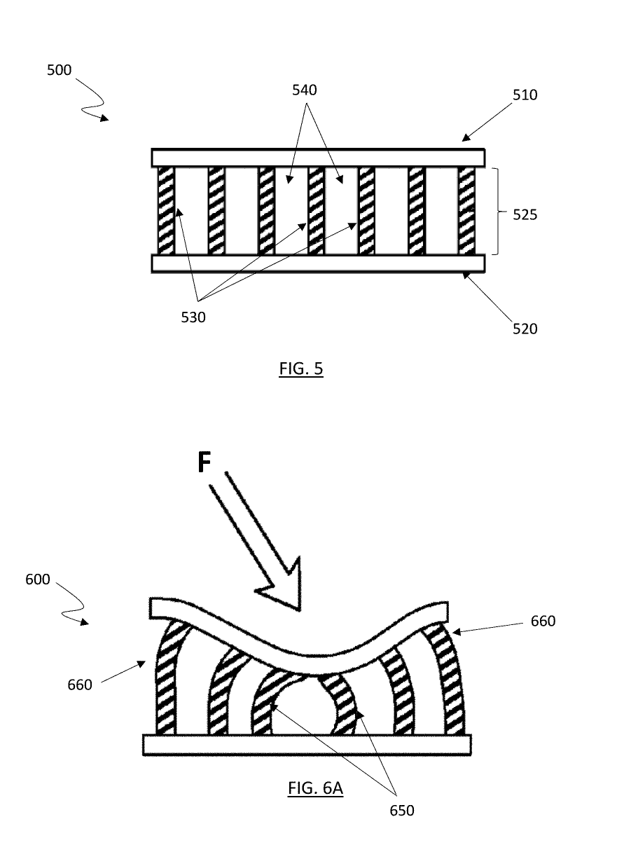

As best seen in FIG. 5, one embodiment of a IAS filament layer 500 can comprise an upper layer 510, a lower layer 520 and space or gap 525 between the upper and lower layers. A plurality of individual filaments 530 can be disposed within the space 525, which may be separated by a series of open areas or voids 540, if desired. In various embodiments, the voids 540 could be filled with air, liquids and/or solid materials such as low-density foam, etc., which might be spaced apart from and/or contact the various filaments, as desired. In the illustrated embodiment, the filaments 530 can extend between the upper layer 510 and lower layer 520, and substantially span the space 525. If desired, padding or other materials (not shown) could be provided adjacent to the upper and/or lower layers, including padding adjacent to the body of the wearer and/or to an inner layer of garment material, which could be configured to comfortably conform to a body surface of the wearer (not shown).

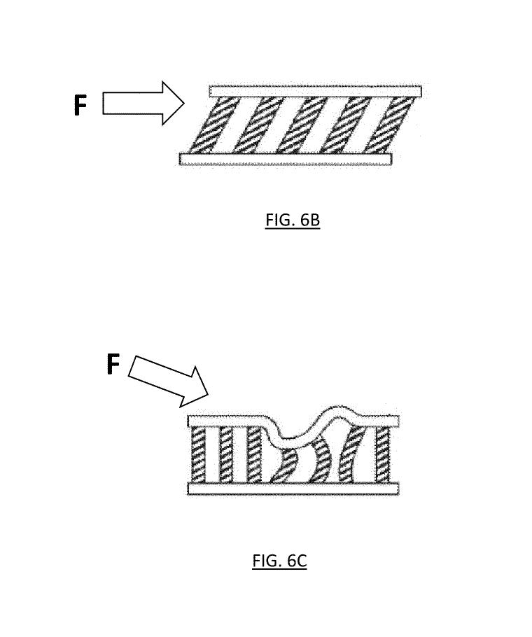

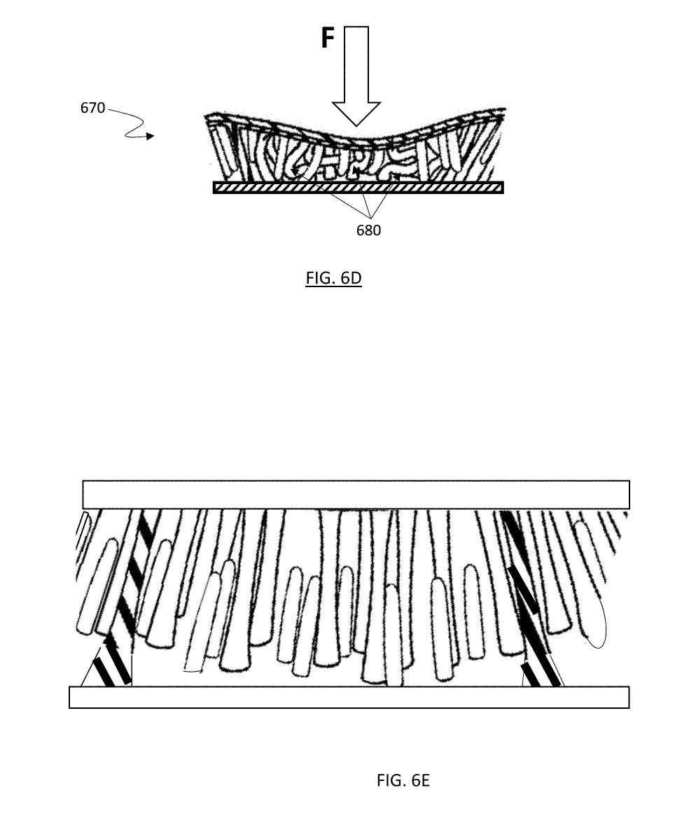

FIG. 6A depicts one potential response of the exemplary filament layer 600 of an IAS to an incident force F, where the magnitude of the incident force causes some centrally located filaments 650 to “buckle” sideways in response to the force, while other peripherally located filaments 660 may “bend” or otherwise compressively deform in a linear or other manner (and possibly “buckle” to some degree, depending upon their proximity to the impact force). FIGS. 6B through 6D show how the columns or filaments of an IAS array may compress and/or “buckle” upon application of an impact, either locally upon impact normal to the sole, or upon a sideways or shear force. FIG. 6D depicts another potential response of an exemplary filament layer 670 of an IAS to an incident force F, where the magnitude of the incident force causes many of the filaments 680 directly below and in proximity to the force F to “buckle” in a complex array of lateral directions in response to the force.

FIG. 6E shows columns, some which of connect to both face sheets, and some of which only connect to one face sheet. This design can provide the ability to reduce impact forces via buckling of the connected columns, and then a second stage of impact reduction as the non-connected columns impact the opposite face sheet and start to buckle.

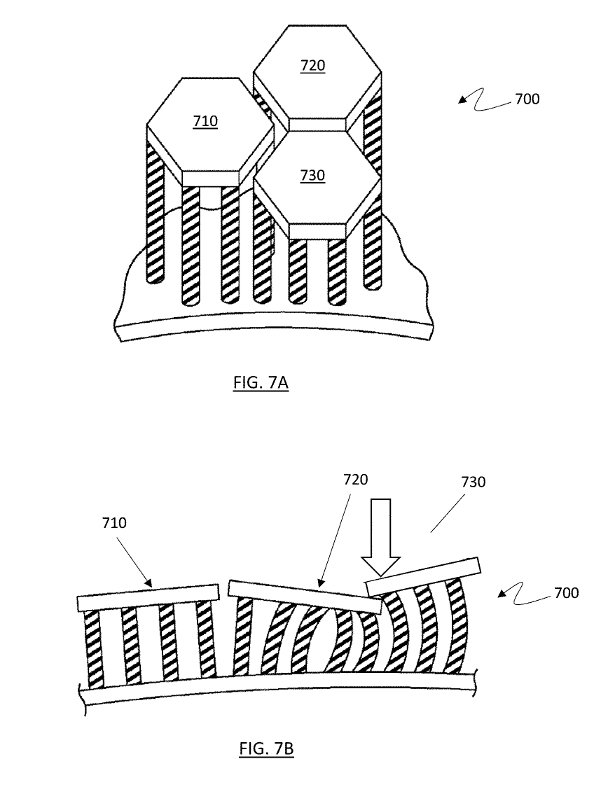

In various embodiments, the impact absorbing structure may incorporate and/or be adjacent to an outer layer that comprises a harder, more durable layer, which may include one or a plurality of impact elements, which may include impact elements capable of independent movement relative to each other. FIGS. 7A and 7B depict one exemplary embodiment of a composite IAS array 700 having a plurality of individual ballistic impact elements or “plates” 710, 720 and 730. In this embodiment, each of the plates is capable of independent movement relative to adjacent plates, including an ability to slide over and/or under adjacent plates under various loading conditions (see FIG. 7B). In other alternative embodiments, the plate arrangement could alternatively allow for independent movement of inner plate sections, such as plate sections adjacent to and/or in contact with the user's body (not shown), if desired, or the independently moving plate sections could be covered by and/or attached to an overlayer of flexible material (i.e., an over-wrap or jacket). As depicted in FIG. 7B, the individual plates are desirably connected or attached to a plurality of individual filaments, which could allow the plates to spread apart when the lower face sheet is flexed, which significantly increases the flexibility of the garment in a desired manner.

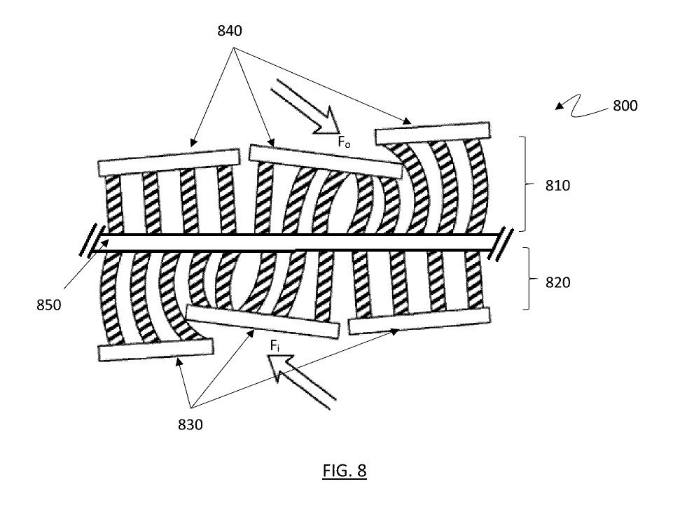

FIG. 8 depicts another alternative embodiment of a IAS layer 800 within a protective garment, wherein the garment comprises an upper filament layer 810 and a lower filament layer 820. This garment includes an outer surface comprising a plurality of outer impact elements 840 (which in this embodiment are depicted as independently moveable relative to each other in response to an outer force Fₒ), as well as a plurality of inner impact elements 840 (which in this embodiment are similarly depicted as independently moveable relative to each other in response to an inner force Fᵢ). An intermediate layer 850 is provided between the upper and lower filament layers, which serves to anchor at least a portion of the filaments relative to each other, allowing each filament bed to independently compensate for forces acting thereupon. If desired, the intermediate layer 850 could comprise a substantially rigid material, or a more flexible material, or various combinations thereof (i.e., differing rigidity/flexibility in different regions of the intermediate layer).

In various embodiments, the outer layer elements 840 can be relatively rigid and/or stiff, thereby desirably preventing projectiles, fragments, projections, rocks and/or debris from penetrating the garment and injuring the wearer and/or damaging the filament layer(s). If desired, the inner layer elements 830 could similarly be relatively rigid and/or stiff, which could include materials suitable for reversing the garment “inside-out” if outer layer elements were damaged, fractured and/or shattered from prior impact and/or combat. In other embodiments, one or both of the inner and/or outer layers could comprise a material pliable enough to locally deform. In some embodiments, the inner and/or outer layers may also comprise a plurality of deformable beams that are flexibly connected and arranged so that the longitudinal axes of the beams are substantially parallel to the surface of the inner/outer layer. Further, in some embodiments each of the deformable beams can be flexibly connected to at least one other deformable beam and at least one filament.

The filaments can comprise thin, columnar or elongated structures configured to deform non-linearly in response to an incident force on the protective garment. Such structures can have a high aspect ratio, e.g., from 3:1 to 1000:1, from 4:1 to 1000:1, from 5:1 to 1000:1, from 100:1 to 1000:1, etc. In various embodiments, a non-linear deformation of the filaments would be desirable to provide the user's anatomy with improved cushioning and protection against high and low-impact direct forces as well as various lateral and/or oblique forces. More specifically, the filaments in one or more regions of the protective garment (and/or other components) could desirably be configured to buckle in response to an incident force, where buckling may be characterized by a sudden “failure” or lateral (i.e., non-axial or non-longitudinal) motion of one or more filaments subjected to high compressive stress, where the actual compressive stress at the point of failure is less than the ultimate compressive stresses that the material is capable of withstanding. Desirably, the filaments will be configured to deform elastically, so that they substantially return to their initial configuration once the external force is removed.

At least a portion of the filaments can be configured to have a tensile strength so as to resist separation of an upper layer from a lower layer (and/or resist rotation of individual attached ballistic plates relative to the lower layer during high velocity impacts). For example, during lateral movement of the upper layer relative to the lower layer, some filaments having tensile strength may exert a force to counteract the lateral movement and/or rotational movement of the upper layer (or portions thereof) relative to the lower layer. In some embodiments, there may be wires, rubber bands, or other elements embedded in or otherwise coupled to the filaments in order to impart additional tensile strength.

As described in various locations herein, the various filament structures may be directly attached to the upper layer and/or directly attached to the lower layer. In some embodiments, at least some of the filaments can be free at one end, with an opposite end coupled to an adjacent surface. Due to the flexibility of the filaments, the upper layer will typically move laterally and/or anteriorly/posteriorly relative to the lower layer. In some embodiments, the filaments could optionally include a rotating member at one or both ends that is configured to rotatably fit within a corresponding socket in the upper and/or lower layers. In some embodiments, at least some of the filaments can be substantially perpendicular to the upper surface, the lower surface, and/or or both.

In the various IAS structures described herein, the filaments and/or other portions of the sole may comprise a variety of suitable materials, such as a foam, elastomeric material, polymeric material, or any combination thereof. In various embodiments, the filaments can be made of a shape memory material and/or a self-healing material. Furthermore, in some embodiments, the filaments may exhibit different shear characteristics in different directions.

In some embodiments, portions of the IAS layer can be configured to deform locally and elastically in response to an incident force. In particular embodiments, for example, the outwardly facing structure(s) of an IAS array can be configured such that, upon application of between about 100 and 500 static pounds of force or greater, the bottom layer and potentially the interface layer may deform between about 0.05 to 0.10 or 0.10 to 0.25 or 0.25 to 0.75 inches. The deformability can be tuned by varying the composition, number, and configuration of the filaments, and by varying the composition and configuration of the upper layer elements and/or the lower layer.

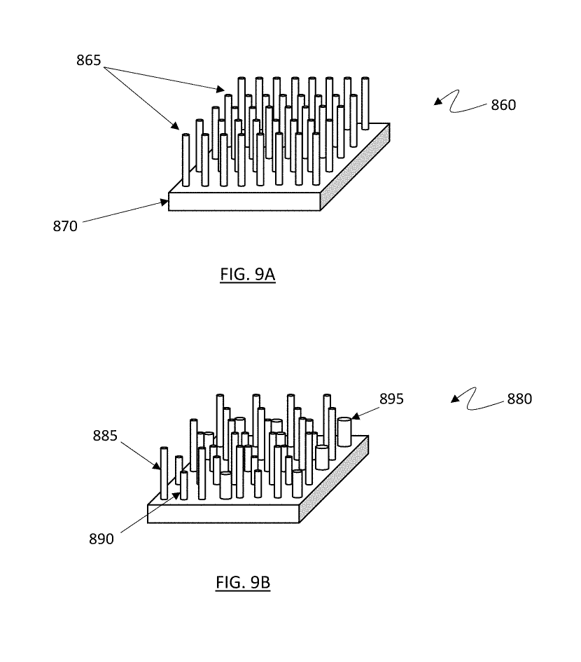

FIG. 9A shows a matrix 860 of generally cylindrical columns or filaments 865 made from an elastic material which could serve as components of an IAS array. These columns may be fixed to a face sheet 870 on one end of the columns or on both ends of the columns, sandwiching the columns between 2 face sheets. The face sheets can desirably lie generally parallel to the planes of the wearer's underlying skin surface, and the skin surface and/or wearer's clothing may serve at least partially as a “face sheet” if the columns are integrally formed in between these structures. FIG. 9B depicts one alternative embodiment of a filament bed 880, wherein the impact absorbing structures therein can comprise long, thin columns 885, short thin columns having a first diameter 890 and short thin columns having a second diameter 895. Such an arrangement can potentially accommodate various impact forces with even more complex resistance, such that the IAS structures described herein could be particularized to respond to a wide variety of forces in a virtually unlimited manner. By altering the size, shape, number, concentration, material properties and/or boundary conditions (i.e., type and quality of connections, if any, to the face sheet or sheets) of the various column-like structures described herein, the impact resistance, surface distortion, energy absorption, deceleration, surface penetration (i.e., intrusion) and/or force distribution from the impact to the wearer's anatomy and/or other object (i.e., items carried by and/or proximate to the wearer) can all be modified in a desired manner.

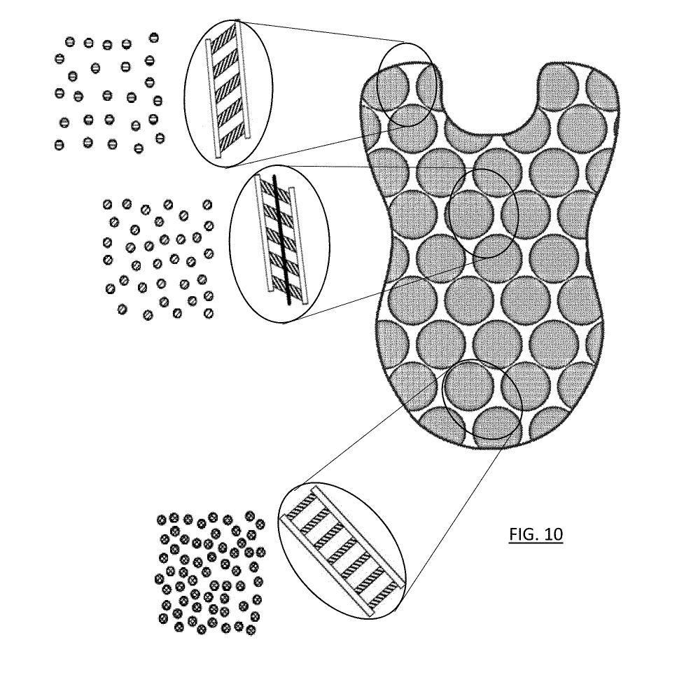

FIG. 10 depicts a protective garment incorporating a plurality of different IAS arrays, with each array particularized for a desired level of garment flexibility as well as a particularized level of protection provide in local areas of the garment. It should be understood that the impact absorbing structures disclosed in the various embodiments herein can be formed into a wide variety of shapes, sizes and configurations, each with their own impact absorbing and/or buckling characteristics, which allows a garment designer to utilize a single material (if desired) to create numerous types of filament beds to accommodate a wide variety of impact forces.

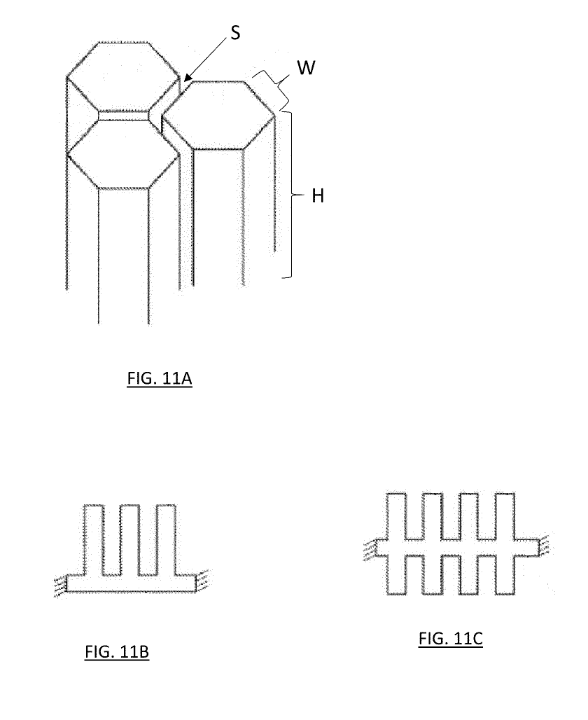

For example, the filaments in an IAS could be formed into a cylindrical shape, which could provide a first impact response. If desired, the cylindrical shape could be altered to a hexagonal cross-section (see FIG. 11A) having a column height H, a face width W and a column spacing S, with each dimensional change altering the impact response and/or buckling of the columns therein. If desired, other cross-sectional shapes could be utilized, including square, rectangular, oval, octagonal, complex and/or even freeform shapes could be utilized. In addition, FIGS. 11A through 11C show some varieties of column or filament construction, wherein the cross section of the columns may be other than cylindrical, and the columns may also be interrupted with other face sheets along the column's length.

Various embodiments of filaments can be configured for an interface or reaction layer (e.g., interface layer) of a protective garment, item or other structure, in accordance with embodiments of the present technology. For example, a plurality of filaments having a cross-sectional shape of regular polygons can be utilized. Individual filaments may have a height, a width, and a spacing between adjacent filaments. If desired, filaments can be connected to an upper surface at one end, and can be free at an opposing end.

In FIG. 11C, filaments can be coupled to a spine at a middle point of the filaments, such that the filaments extend outwardly in opposite directions from the spine. If desired, the filaments can assume virtually any suitable shape, including cylinders, hexagons (inverse honeycomb), square, irregular polygons, and/or random forms.

If desired, the various constraints on the columns or filament could be altered in a variety of ways to modify the impact response of the IAS array. For example, one or both of the ends of the column(s) or filament(s) could optionally be secured to one or more face sheets, which could include complete constraint of the filament end to the face sheet as well as partial constraints (i.e., the filament is constrained in lateral movement but allowed to rotate relative to the face sheet, or is constrained in rotation but allowed to move laterally relative to the face sheet). By altering the boundary conditions of the filaments relative to the face sheets, the buckling response and/or impact response of the IAS can be significantly modified in a desired manner.

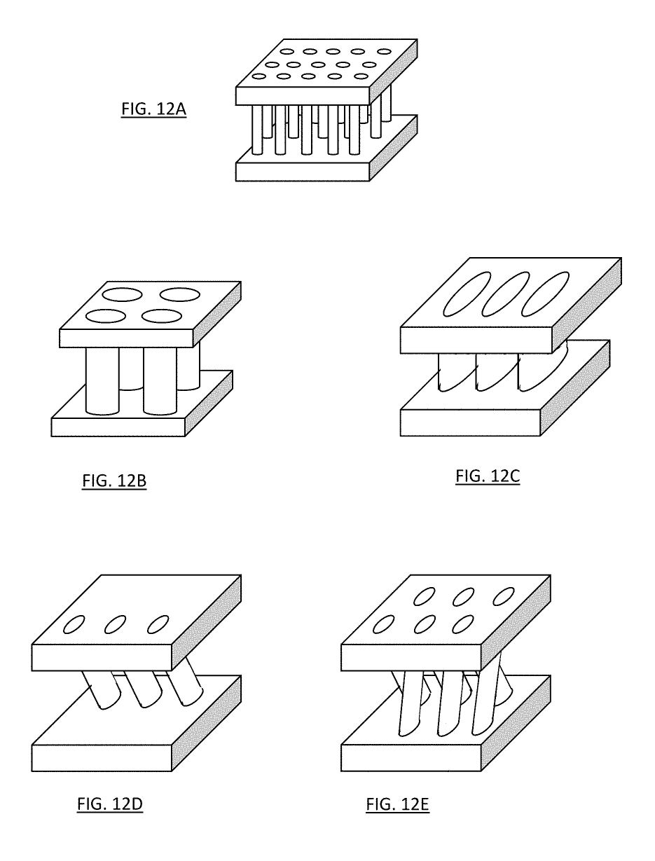

FIGS. 12A through 12E depict various alternative embodiments of filament arrangements in IAS arrays, each of which can potentially provide varying responses to impact forces. For example, FIG. 12A depicts a dense network of densely spaced smaller diameter columns (which can be regularly or irregularly spaced, as desired), while FIG. 2B depicts a lower density network of larger diameter columns. FIG. 12C depicts a network of oval or elongate-shaped columns, which may deform and/or buckle in one or more desired directions, while FIGS. 12D and 12E depict networks of non-normal oriented (i.e., “tilted”) columns, which can be biased in directions other than normal to the face sheets (i.e., FIG. 12D showing filaments at an angle, and FIG. 12E shows sets of crossed filaments).

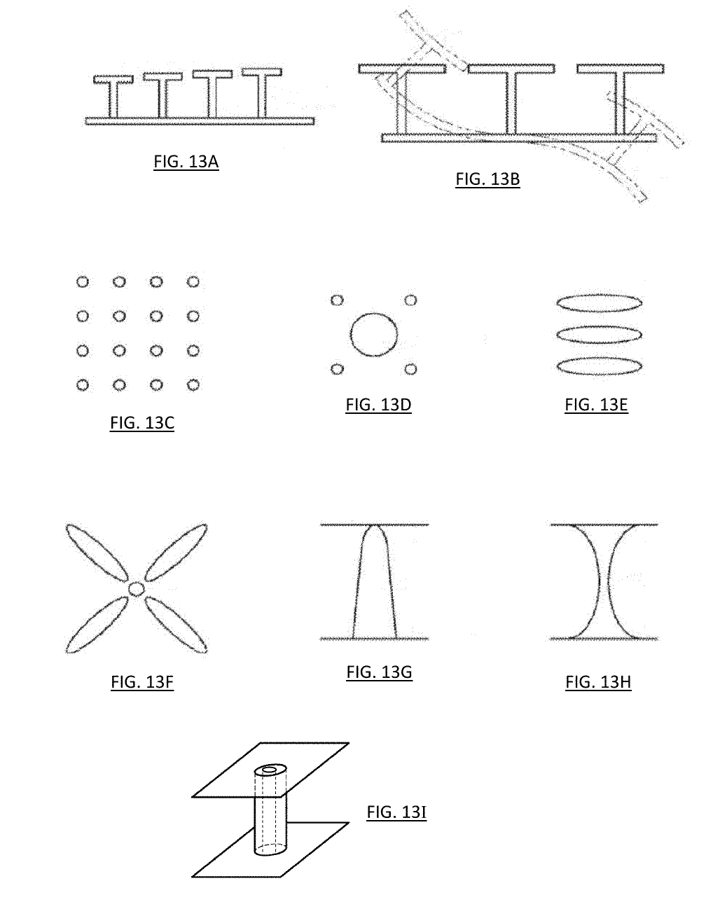

FIGS. 13A through 13I depict additional alternative embodiments of exemplary IAS filament arrays, including embodiments comprising a variety of column cross-sections and configurations. If desired, columns may differ along their diameter (i.e., they may be conical, frusto-conical, complex, hourglass-shaped, swab-shaped, etc.), and various filaments/columns may comprise different sizes, shapes, configurations and/or materials within a single filament bed and/or within a single garment or garment component, depending upon the impact absorption profile required in different parts of the protective clothing.

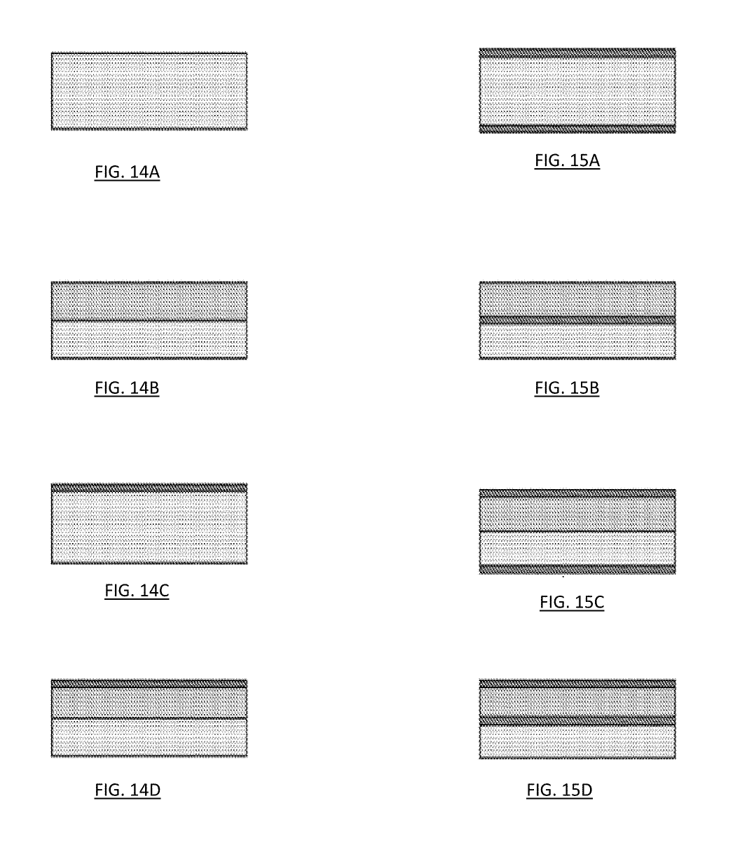

FIGS. 14A through 14D are cross section examples of various IAS configurations potentially useful in addressing impact forces as described herein. In various embodiments, the IAS configuration may be oriented as shown (with the outside environment proximate the top of the structure and the wearer's anatomy or adjacent contact surface proximate the bottom of the structure), or the structure could be inverted in use (i.e., with the environment proximate the bottom of the structure as depicted in the figures, and the protected anatomy proximate the top of the structure in the figure), or any angle or variation thereof. FIG. 14A depicts a single IAS layer with a same density throughout. FIG. 14B depicts a multiple IAS layer (which may include one or more layers of foam or other currently existing impact absorbing materials) with multiple densities of IAS arrays or matrices. FIG. 14C depicts a single IAS layer with a solid, semi solid and/or partially flexible outer/inner solid layer. FIG. 14D depicts multiple IAS layers of differing density with an outer/inner solid layer.

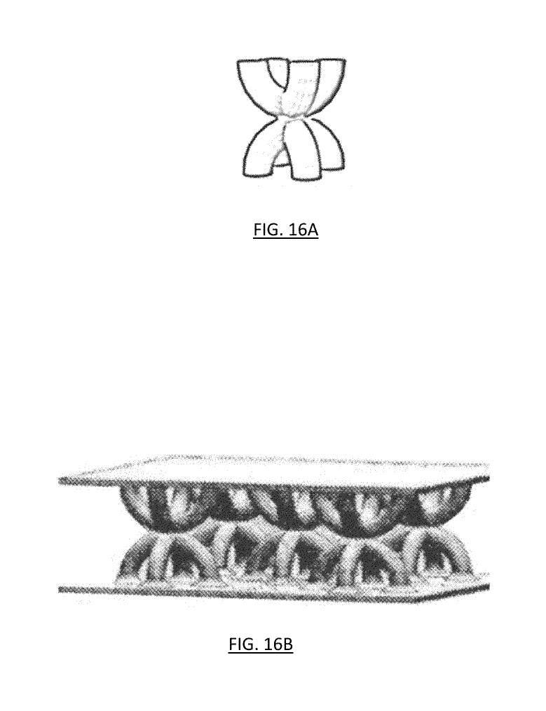

FIGS. 15A through 15D are exemplary cross-sectional depictions of various solutions to design protective garments and/or other items (i.e., hard or soft goods) incorporating IAS arrays. Many of these solutions can involve combining any combination or single layer of foam, inflatable air and/or liquid bladders, flexible and/or elastic materials and/or other materials (including hard or rigid materials) with the various IAS layers depicted herein, including those shown in FIGS. 15A through 15D. For example, FIG. 15A depicts an IAS layer with one layer or multiple layers of solid material surrounding the IAS filaments. In this embodiment, the solid layer or layers desirably help to distribute impact loads into the impact absorbing structure to create a larger area of the absorbing material than just the area which is struck and/or otherwise directly affected by an impact. In each figure, the IAS or solid layers shown by different shading can either be similar to each other or different in size, shape, structure or material. Likewise, structures shown in each figure in the same shades could (but not necessarily are) either be similar to each other or different in size, shape, structure and/or material.

As previously noted, FIG. 15A depicts an IAS web or mesh material having a solid or semi-solid layer on both the inner and outer surfaces. FIG. 15B depicts a solid or semi-solid layer in between two IAS layers. FIG. 15C depicts multiple IAS layers, with a solid layer is on both the inner and outer surfaces. FIG. 15D depicts multiple IAS layers, with a solid layer on the outer surface and another solid or semi-solid surface between them. In various embodiments, the “solid” layer could be a layer of relatively more rigid and/or denser material that can distribute an impact load to a larger surface of the IAS, and/or could be a more durable surface for abrasion and/or impact resistance. If desired, the “solid” layer could comprise multiple pieces that are nested or grouped together to allow for the layer to flex and take shape with the contact surface and/or user, as desired. The individual pieces of each IAS web could incorporate virtually any shape, and need not necessarily be repeating the same shape as they may be designed to allow for more or less flexibility in different areas of the product. In addition, various embodiment may allow the pieces to overlap in a manner similar to scale armor or armadillo skin plates, and the individual components need not necessarily be spaced uniformly or in any particular manner except as desired.

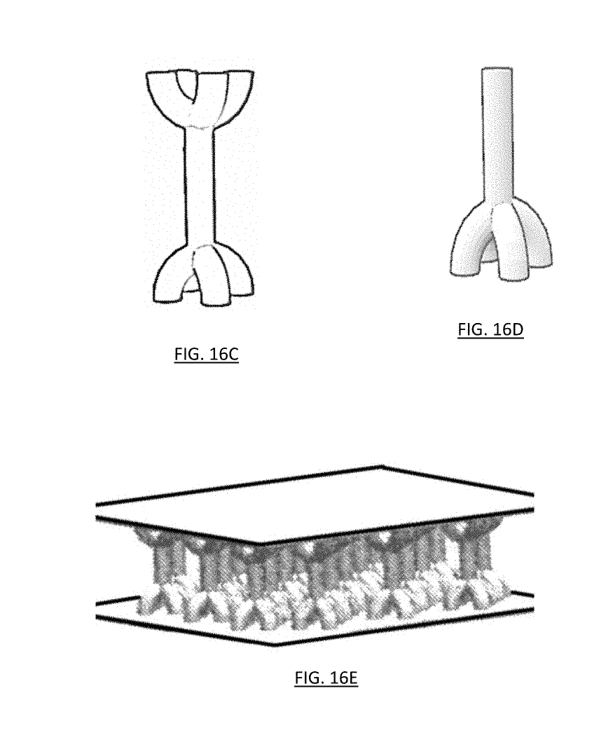

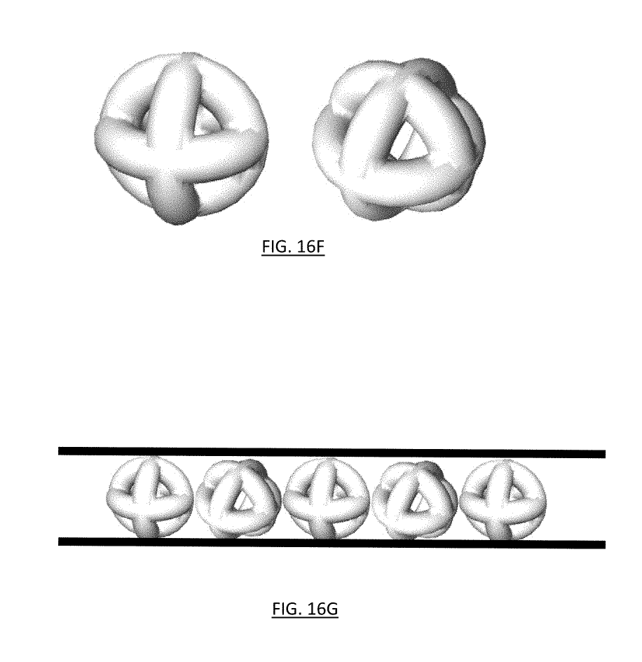

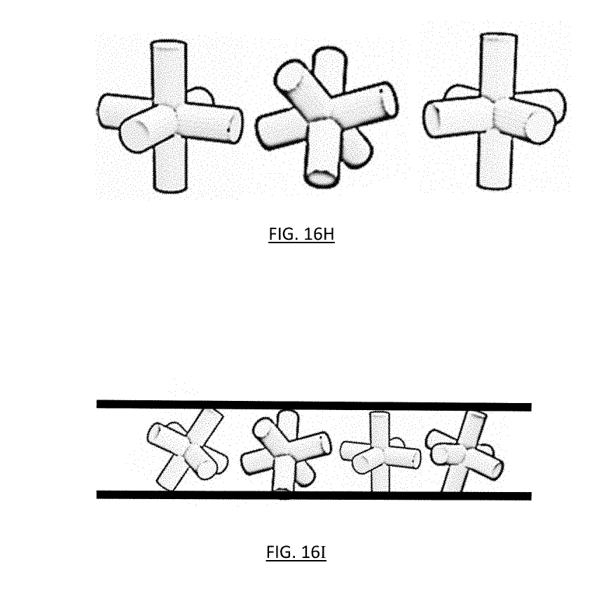

FIGS. 16A though 16I depict various alternative embodiments of structural elements of IAS arrays that could be incorporated into various protective garment components, including placement between an outer impact layer and an inner layer, to reduce transmission of impact forces in a variety of ways.

Venting, Cooling and Sweat Management

One potential significant advantage of incorporating IAS filaments and/or similar arrays in the management of impact loading in protective garments is that ability of certain buckling structure designs to accommodate the free passage of air, water, sweat and/or air vapor through and/or within the IAS array without significantly affecting its utility. In fact, in certain array designs, impact absorbing structures can be designed that actively “pump” and/or otherwise transfer sweat and/or water vapor away from a user's body surfaces, and may also provide fresh air to various regions of the user's anatomy. For example, the buckling structure depicted in FIG. 13I can incorporate a central lumen, which can be in fluid communication with a corresponding opening formed through the inner surface of a protective vest or garment, with the central lumen similarly in communication with one or more openings in the sides of the garment (with a plurality of such structures forming an IAS array corresponding to multiple perforations in the inner garment fabric). During use, the wearer will typically flex and/or otherwise displace the IAS array within the garment, which will likely buckle and compress or collapse some of the hollow filaments, causing air and/or other materials within those filaments to potentially travel away from the inner garment surface and/or outwards from the garment. At other times, the filaments will desirably rebound and assume an unbuckled and/or uncompressed condition, potentially drawing air and/or fluids away from the user's anatomy and/or drawing fresh air into the garment structure. Repeated steps will desirably evacuate unwanted air and/or fluids, which could be augmented by the incorporation of biasing structures such as one-way valves and/or other arrangement to facilitate the resulting “pumping” action in a desired manner.

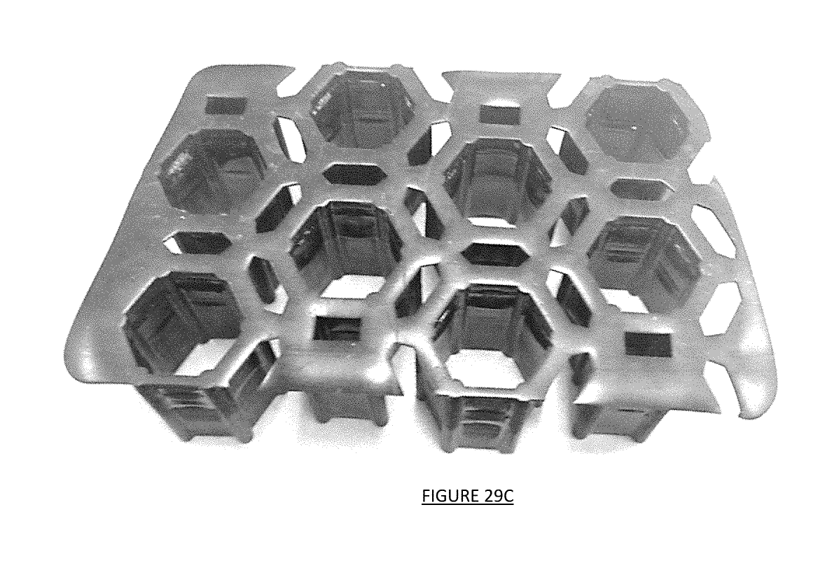

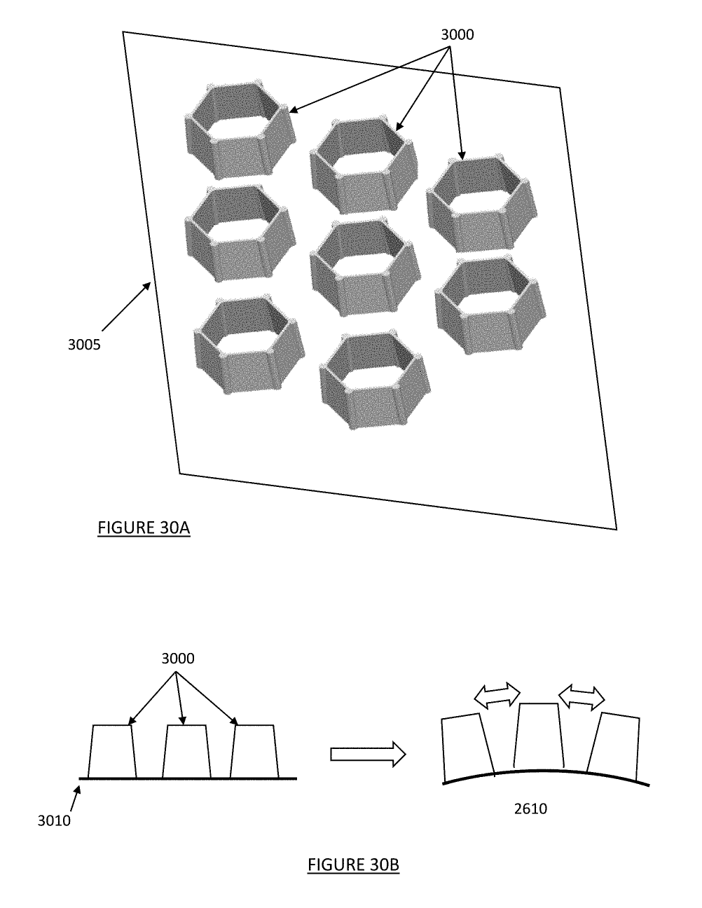

In various alternative embodiment, the inner and/or outer face sheets of the IAS array within the protective garment could comprise an “open lattice” construction (see FIGS. 29A and 29C, for example), wherein the upper portion of the buckling structures could face away from the wearer's anatomy, which could optionally include the absence of an upper face sheet (or potentially only the presence of a perforated and/or air/water/vapor permeable upper face sheet), possibly allowing air within and/or between the various buckling structures venting structures to “bathe” the user's anatomy and/or undergarments with fresh air and/or remove moisture and/or sweat from body regions. In drier climates, this removal and pumping action might have the added benefit of providing some level of evaporative cooling to the user's anatomy, which would be an extremely desirable feature for a wide variety of applications and environments.

Modification, Customization and Performance Enhancement

A variety of potential benefits conferred by the incorporation of buckling structures and other IAS array designs into protective garments and/or other clothing is the ability to “tune” or otherwise modify the “response” of the impact absorbing structures in unique ways as compared to the traditional methods of selecting different foam materials, textiles, padding and/or material combinations for protective garments. Because IAS structures can provide non-linear responses to impact loading, and because the individual structures within IAS arrays can be designed to respond in different manners due to variations in the speed, intensity, magnitude and/or directionality of impact loads, the present disclosure now makes it possible to design a protective garment that independently optimizes its performance for various environments and/or activities. For instance, IAS structures can be incorporated into low-velocity protective clothing that maximize cushioning and/or rebound of the IAS array to reduce impact transference to a wearer, but the same structures can instantly “shift” to a more “rigid” configuration that maximizes energy absorption where the individual experiences a high-velocity impact from a projectile such as a bullet or shell fragment. Moreover, the same structures can potentially provide enhanced lateral and/or shear stability that can be useful for ameliorating high-velocity impacts without sacrificing lower-velocity impact protection.

If desired, IAS arrays and buckling structures can incorporate structures and/or materials that could be “rate sensitive” and/or “directionally sensitive,” including materials that may “harden” or otherwise modify their properties under stress and/or strain. Such materials could be provided in some embodiments to surround filament structures, while in other embodiments such materials could be contained within the filaments (i.e., a filament having a hollow core) and/or could be incorporated into the filament materials themselves as well as one or more layers proximate to a face sheet.

In various embodiments, filaments and other buckling structures within an IAS array (or the array itself) could incorporate one or more of the following to alter and/or tune the properties of the array: (1) magnetic and/or ferrous fluids surrounding and/or internal to the buckling structures (to desirably allow altering of the buckling properties), (2) magnetic particles incorporated into the various polymers used in forming the buckling members, (3) piezoelectric materials incorporated into and/or adjacent to buckling structures to desirably create electricity and/or alter materials/adjacent fluids, (4) rate sensitive materials to alter buckling performance and/or protect anatomical structures (i.e., steel plate-like materials that are normally soft and pliable), (5) structures that can include separated regions, with each region tunable to different characteristics, (6) buckling structures that are contained within a collapsible “bag” or tube, which in some embodiments can be pressurized and/or evacuated, and/or (7) metallic or rubberized buckling structures—i.e., buckling springs designed similarly to IBM's buckling keyboard spring design.

In addition, the point(s) of connection between filaments and the surrounding surfaces and/or internal spines, the dimensions, the filament material(s) and the material(s) in the space between the filaments can all be optionally modified to tune the orthotropic properties of the filaments. This tunability is expected to provide desired deformation properties and can be varied between different regions of the interface layer. Filaments can be made from materials that allow large elastic deformations including, for example, foams, elastic foams, plastics, etc. The spacing between filaments can be filled with gas, liquid, or complex fluids, to further tune overall structure material properties. In some embodiments, for example, the space can be filled with a gas, a liquid (e.g., a shear thinning or shear thickening liquid), a gel (e.g., a shear thinning or shear thickening gel), a foam, a polymeric material, or any combinations thereof.

In various embodiments, a shear responsive and/or shear hardening material can be incorporated into the filaments, the spaces between filaments and/or within one or more layers and/or face sheets, including the use of materials that can stiffen and/or harden in response to impact forces, such as PORON XRD urethane (commercially available from Rogers Corporation of Rogers, Conn., USA). Such impact responsive materials may allow for flexibility and/or softness of various structures under normal wear and/or use, with alterations in the stiffness or other material properties occurring in the material in response to an impact and/or other external or internal factor. In at least one exemplary embodiment, a Poron XRD foam can be incorporated into and/or between one or more layers of the various embodiments described herein. If desired, other strain hardening and/or impact-hardening materials may be incorporated therein, including D3O (commercially available from Design Blue Ltd of Brighton and Hove, United Kingdom), PORON XRD and/or DEFLEXION silicon-based impact protection textile (commercially available from Dow Corning Corporation of Corning, N.Y., USA). In at least one exemplary embodiment, PORON foam can be layered between an upper impact layer comprising adjacent and/or interleaved ballistic or other impact discs or plates and a lower layer comprising one or more reflex or filament layers (i.e., IAS arrays), as described herein.

In various cases, IAS arrays can be employed to design a protective garment that can perform in different manners during different activities, which might incorporate automated or semi-automated selectable “switching” functions (i.e., the IAS independently could accommodate different loading patterns experienced under different combat conditions and/or in different environments) or which might incorporate user-selectable features that enable to user to alter IAS performance as they desire. For example, a protective garment design incorporating IAS arrays could accommodate lower-velocity impacts experienced by a tank driver when they are located inside of the tank (i.e., impacts due to tank movement and/or bumps in the road), but the IAS arrays therein could perform differently to accommodate high-velocity impacts if the tank driver were forced to “bail out” of the tank and had to engage in open field (i.e., infantry) combat. In this manner, the same garment design might further be capable of modification to accommodate the demands of the wearer either automatically and/or with the “click” of a button.

In other alternative embodiments, the buckling and/or IAS arrays (or individual structures thereof) could be positioned in other directions, include cross-ways and/or side-ways in the protective garment, as well as virtually any angle relative thereof, with potentially considerable variation in orientation between even the individual filaments within a single IAS array.

In various alternative embodiment, IAS arrays and/or buckling structures could be incorporated within a contained space or “bag” in which a material, fluid and/or air surrounding the buckling structures could be modified (i.e., increased or decreased in pressure using a detachable or attached pump or other device), which may have the added benefit of potentially modifying the impact absorption response of the buckling structures themselves. For example, where buckling structures might comprise a closed-cell foam material, an increase in the localized air or liquid pressure (i.e., by “pumping up” the pressure in the bag) might alter the shape and/or size of the buckling structures themselves (i.e., the increased surrounding pressure might cause the foam buckling structure to shrink in diameter, thereby altering its physical response to impact loading), which could potentially reduce the compression resistance of the overall IAS array, even though the pressure inside of the bag might have been increased.

If desired, a protective garment design could include one or more “swappable” inserts or similar structures incorporating IAS arrays that could allow a user to quickly and/or conveniently modify the performance of a garment. For example, a removable “trauma plate” or similar structure(s) could be provided that could be exchanged for other inserts having different IAS arrays and/or attached impact resistant structures/plates providing different impact responses, which could be swapped out for different activities. In various other embodiment, swappable inserts could include sensors to measure and/or record performance, provide added stored power (i.e., impact resistant battery packs) and/or contain computing or telecommunications resources which could potentially monitor and/or assist the wearer in various ways.

Medical Detection/Treatment Applications

In various embodiments, IAS arrays and/or buckling structures could be incorporated into protective garments and/or other extremity protection devices to monitor, detect, treat, accommodate, ameliorate and/or correct various medical conditions, as well as potentially prevent or delay the onset of various medical conditions not currently addressed by current garment designs. For example, a protective vest or other garment (including, but not limited to, braces, wraps and/or casts), could incorporate one or more IAS arrays that also include sensors for detecting the temperature, heart rate, breathing patterns and/or physical condition of the wearer. If desired, the garment could include features to rigidify portions of the garment and/or “lock up” or limit motion of a flexible joint in the event that an injury to the wearer is detected, as well as features to treat the wearer (i.e., using an automated high-pressure medication injection and dispensing systems integrated into the IAS and/or insert).

Sensor Systems

If desired, a IAS array could incorporate sensors that sense, read and/or record various information about the wearer and/or the array, which could alternatively include a removable sensor system and/or external sensor system. If desired, a sensor system contained within a protective garment could potentially collect use data (i.e., real-time and/or stored data), which in various embodiments could be transmitted or uploaded via Bluetooth or other wireless (or wired) technology to a smart phone, smart watch, headband-based computer or sensor array, equipment with installed data readers and/or personal fitness tracking device (i.e., Fitbit™) for analysis and/or use. Such data could be utilized to identify medical conditions of the wearer, environmental conditions (i.e., ambient temperature and/or humidity) and/or information about the protective equipment conditions (i.e., detecting a projectile impact on the garment), which might then be utilized to alter IAS performance and/or notify the wearer and/or other individuals about IAS performance changes. If desired, a garment IAS array incorporating modifiable features could be activated by an external and/or internal computing device or monitor to actuate changes to the localized stiffness or other performance of the IAS array of the wearer's protective garment—functions which might be performed automatically and/or manually with user input.

Energy Harvesting

If desired, IAS arrays and/or buckling structures could be incorporated within various garment structures and/or components to generate and/or harvest energy for use in powering various devices and/or components. For example, IAS arrays and/other buckling structures in a garment design could incorporate piezoelectric beams or other energy generating structures in some or all of the array, with the buckling and/or stretching of the beams during movement generating such energy in a known manner of movement and beam deformation. Where the piezoelectric beams formed only a portion of the IAS array, the remaining filaments therein could provide particularized impact absorption and/or resistance as described herein. If desired, the energy created by the beam deformation could be utilized to power various devices within the garment (i.e., to provide communication with external devices, provide internal computer processing power and/or to modify IAS performance) and/or energy could be stored (i.e., within a “impact resistant battery”) and/or the garment could be linked with external devices (i.e., using a USB or other-type connection) to provide external power to other devices.

Flexible Inserts and IAS Structures

In various embodiments, IAS arrays and/or buckling structures might be incorporated into fabric and/or highly flexible structures such as tapes or wraps, which could provide added comfort and/or shock absorption ability. Unlike traditional foams and/or other shock absorbing materials, IAS arrays and/or buckling structures can be designed from durable and/or washable materials (potentially including the same material from which a fabric itself is constructed), which can often retain their performance enhancing properties throughout hundreds of washing cycles. Accordingly, a fully flexible layer, tape, sock or flexible insert can be created, which could be utilized with existing protective garment technology, if desired.

Composite IAS Arrays

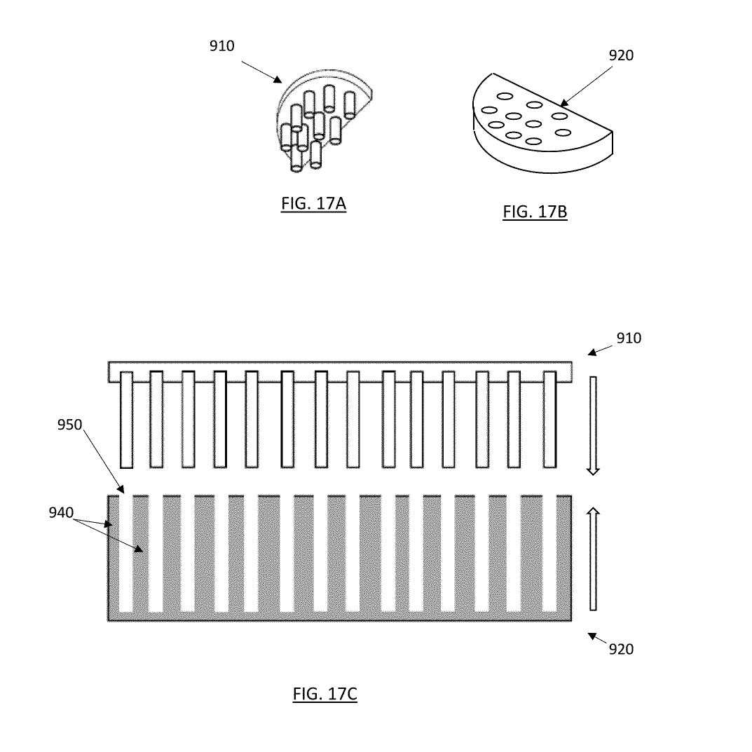

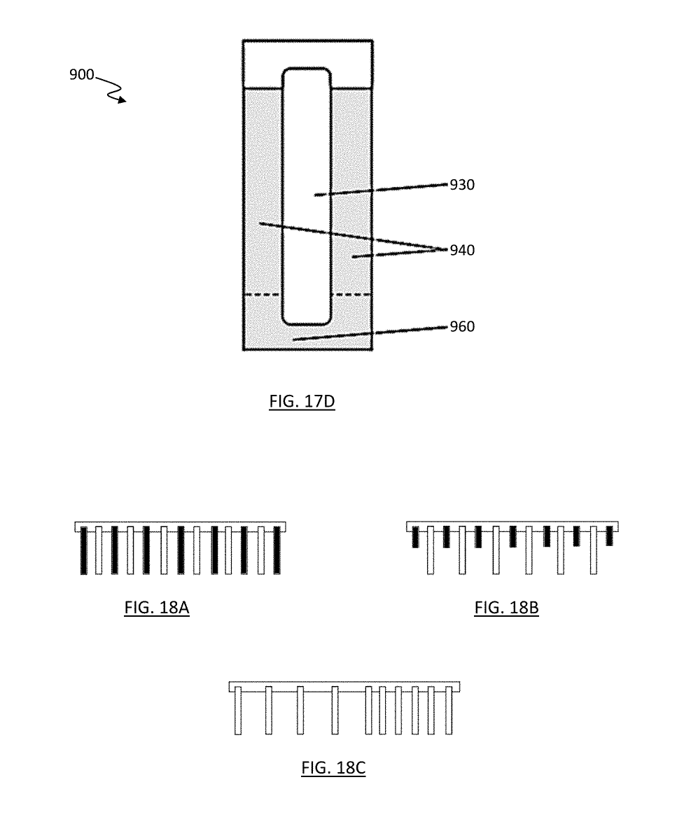

In various embodiments, a multi-component or “composite” IAS array system could be provided that allows a potential user to select from a variety of individual elements that, when combined together, create an insert or other component having unique performance features to suit the user's needs. Such “composite array” systems can include a limited number of components that can be “mixed and matched” in a variety of ways. For example, FIGS. 17A and 17B depict two possible components of a composite IAS array 900, comprising an upper component 910 and a lower component 920, which when combined together can create a composite insert component 900 for insertion into a pocket or other feature of a protective garment (i.e., similar to a trauma plate in existing protective vests).

As best seen in FIGS. 17C and 17D, one embodiment of a composite IAS array 900 can comprise an upper component having a top face 920 and a plurality of buckling structures 930 extending downward therefore. The lower component can include a body 940 having a plurality of voids 950, with each void 950 facing upward and desirably corresponding to a buckling structure 930. When the upper and lower components are combined together, such as shown in FIG. 17D, the array 900 will desirably include a buckling structure 930 encased in within the lower component void 950 (with the body 940 potentially fitting tightly around the buckling structure and/or may be a looser fit with gaps around the structure). In this embodiment, a distal tip of the structure can fit within and engages with a lower face sheet of higher density foam 960 to better secure the lower end of the buckling structure in a desired manner. FIGS. 18A through 18C depict alternative upper components that could be provided with the single lower component to alter the insert performance as desired. The lower insert of FIG. 18A could include buckling structures of differing shapes and/or densities, while the lower insert of FIG. 18B could include shorter, more rigid columns to provide additional shear resistance in certain designs. If desired, the lower insert of FIG. 18C could include a reduced number of buckling structures, with some voids in the lower component left unfiled when the upper component is mated thereto. If desired, the distal ends of the buckling structures could be tapered to more easily fit within the voids of the lower component.

In various embodiment, the lower component could comprise a “block” of foam or other material having multiple holes or tubes facing upward formed therein, with the upper structure comprising a series of filaments or columns facing downward (like a comb or hairbrush). If desired, the upper structure could further comprise a substantially rigid material, such as a metal or ceramic “trauma plate” or similar feature. At the user's option, sliding the two structures together could create a composite structure with unique compression/buckling characteristics. Different materials and structural sizes/shapes could produce different linear and/or non-linear response curves (and combinations thereof, if desired), and the individual components could potentially be utilized individually (i.e., even used without being mated to the opposing component), or combined with other components as desired. Moreover, in various embodiments a lower density foam section(s) in the lower component could include regions of lower/higher density or stiffness to direct buckling in a desired direction (i.e., higher density foam could be positioned on left of a column with lower density foam on the right of the same column, such that the column preferentially buckles to the right side. If desired, different densities on differing sides of the column(s) and/or along the length of a column could similarly be provided.

Lateral and Shear Loading

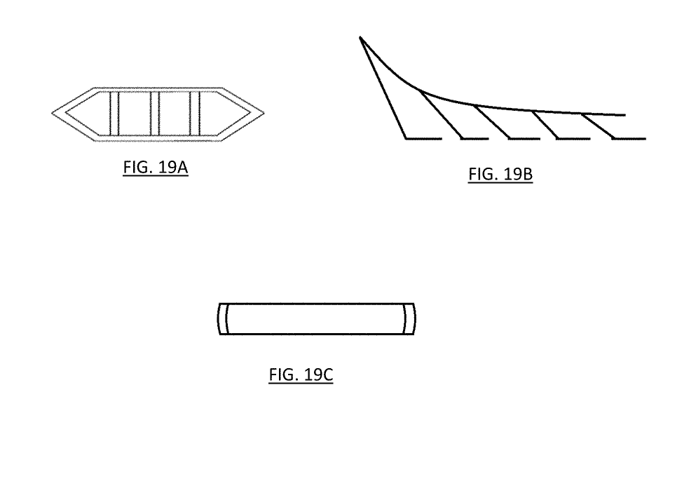

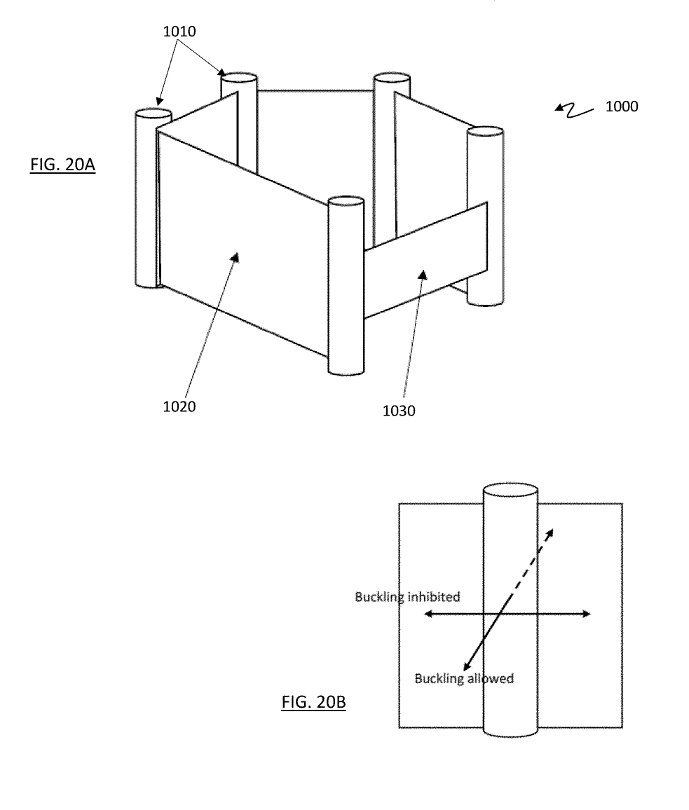

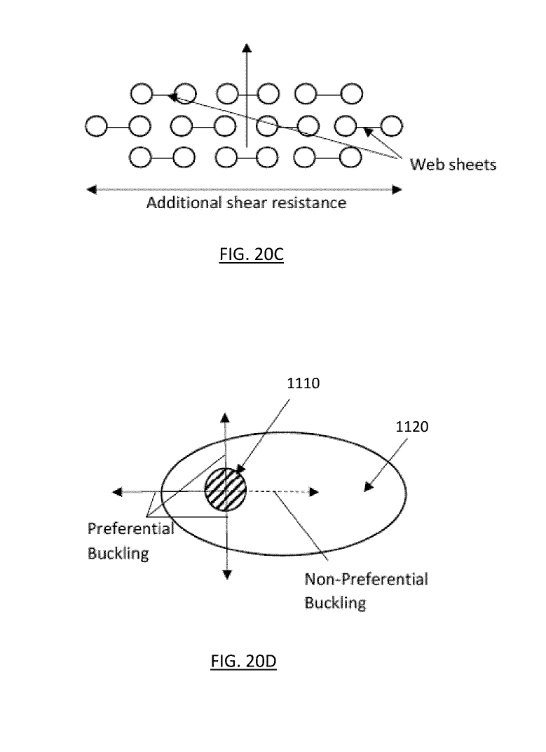

In various embodiments, IAS arrays and/or buckling structures can include various features to address lateral or shear loading of the array/structure in a desired manner. For example, an IAS array can include external or boundary walls or similar features that absorb and/or otherwise resist lateral loading of the filament array (see FIGS. 19A through 19C), or internal walls and/or filament arrangements absorb and/or otherwise resist lateral loading applied thereto (see FIGS. 20A and 20B).

If desired, IAS or boundary structures could be provided that inhibit lateral deflection in some areas, potentially allowing deflection in other areas and/or directions. For example, one exemplary IAS array design could include a solid or semi-solid connection at a periphery and/or within the array to inhibit side-to-side and/or lateral motion of various structures, while allowing significant vertical deflection and buckling to accommodate the axial impacts into the garment. If desired, the filament structures within an IAS array in a garment could include or be contained by boundary walls and/or other structures (i.e., internal and/or external to the “buckling array”) that could accommodate some or all shear/lateral forces in an outer region, while a central region could more easily buckle to accommodate vertical impacts. In a similar manner, lateral force resistance could be accomplished by appropriate filament design, which could include boundary walls and/or internal restraint webs that resist shear in one or more directions, while allowing buckling in other loading mode(s).

If desired, the IAS array and/or buckling structures within the array could incorporate a variety of boundary or “control” arrangements to prevent and/or inhibit buckling and/or other deformation in one or more directions or modes. For example, FIG. 20A depicts an IAS array 1000 incorporating a plurality of filaments 1010 connected by sheets 1020 and/or tension bands 1030 therebetween. In this embodiment, the filaments are desirably inhibited from buckling in certain directions, while allowed to buckle freely in other directions (see FIG. 20B). While tension bands and/or sheets are depicted in this embodiment, other similar arrangements are possible, including bands or sheets capable of withstanding compressive loading (i.e., by thickening the band, for example). In addition, the sheets and/or tension bands could be “raised” or “lowered” relative to the upper and/or lower face sheets (and need not be centrally located along the filament), further modifying buckling resistance to achieve a desired impact force response. The sheets/bands and similar structure(s) could also be angled, if desired (i.e., connecting a midpoint of one buckling structure to a lower half of an adjacent buckling structure, or the like). FIG. 20C depicts a top plan view of one potential IAS array incorporating a sheet connection arrangement desirably suitable for resisting lateral shear forces to some degree.

FIG. 20D depicts an alternative arrangement for constraining the buckling response of filaments in a desired manner, in which thicker and/or higher density foam or other material surrounds a buckling structure, desirably inducing the buckling structure to “fail” or otherwise buckle in one or more preferential directions. In this embodiment, the buckling structure 1110 can be surrounded by a foam 1120 or outer column structure (which might incorporate a rate sensitive liquid, in various embodiments). This surrounding structure could desirably resist and/or impeded buckling of the structure in various directions, while allowing or promoting buckling in others.

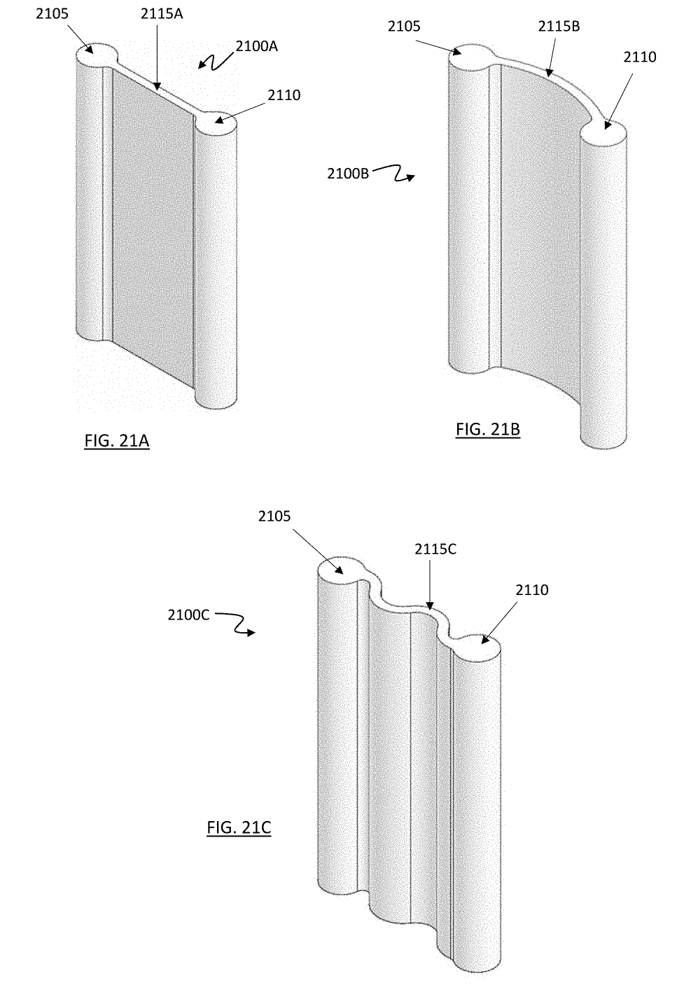

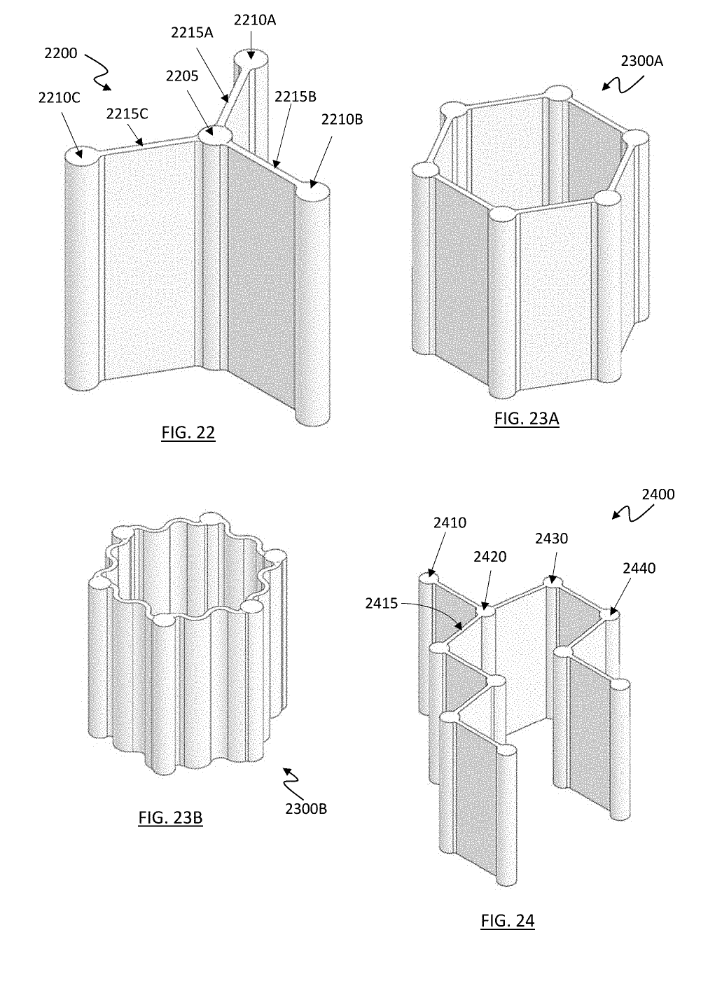

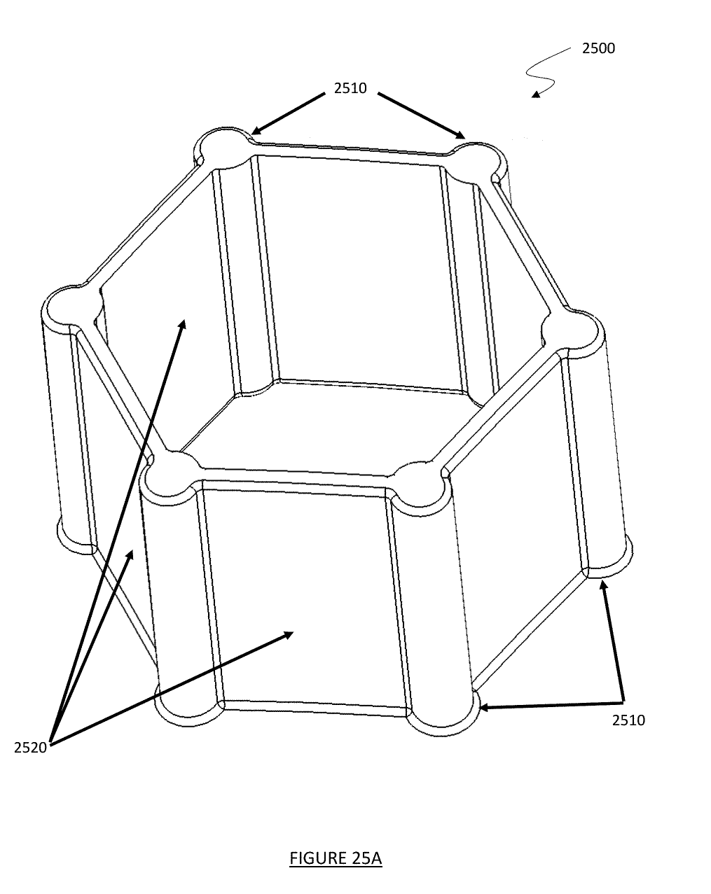

FIGS. 21A through 21C show perspective views of additional embodiments of impact absorbing structures 2100A, 2100B, 2100C comprising connected support members 2105, 2110. Each support member 2105, 2110 has at least one end configured to be coupled to a surface or face sheet (not shown), with an opposing end optionally configured to be coupled to another face sheet or other surface (not shown). A support member 2105 is coupled to the other support member 2110 by a connecting element that is desirably in a plane perpendicular to a plane including the face sheet, or in a plane perpendicular to another plane including the optional other face sheet or surface. In the example of FIG. 21A, an impact absorbing structure 2100A may include a rectangular sheet-like or wall-like structure 2115A connecting the support member 2105 to the other support member 2110, with this wall structure positioned perpendicular to one or both face sheets. In various embodiments, one or both ends of the rectangular structure 2115A could optionally be coupled to the face sheet(s) or other surfaces.

FIG. 21B shows an impact absorbing structure 2100B including a non-planer surface or “arched” wall structure 2115B connecting the support member 2105 to the other support member 2110. The arched structure 2115B can be perpendicular to one or both of the face sheets or other surfaces, and as depicted is arched in a plane that is parallel to the face sheet. In various embodiments, one or both ends of the rectangular structure 2115B could optionally be coupled to the face sheet(s) or other surfaces.

FIG. 21C shows an impact absorbing structure 2100C including a complex or “undulating” wall structure 2115C connecting the support member 2105 to the other support member 2110. The undulating structure 2115C can desirably be perpendicular to one or both of the face sheets or other surfaces, and may include multiple arcs in a plane that are parallel to a face sheet. For example, the undulating structure 2115C may have a sinusoidal cross section in a plane parallel to the plane including a face sheet. In various embodiments, one or both ends of the structure 2115C could optionally be coupled to the face sheet(s) or other surfaces.

While FIGS. 21A through 21C show examples of impact absorbing structures where a pair of support members are coupled to each other by a connecting member, any number of support members may be positioned relative to each other and different pairs of the support members connected to each other by connecting members to form structural groups. FIGS. 22 through 24 show exemplary structural groups including multiple support members positioned relative to each other with different support members or filaments coupled to each other by connecting members or walls. FIG. 22 shows an impact absorbing structure 2200 having a central support member 2205 coupled to three radial support members 2210A, 2210B, 2210C that are positioned along a circumference of a circle having an origin at the central support member 2205. The central support member 2200 is coupled to radial support member 2210A by connecting member 2215A and is coupled to radial support member 2210B by connecting member 2215B. Similarly, the central support member 2200 is coupled to radial support member 2210C by connecting member 2215C. While FIG. 22 shows an example where the connecting member 2215A, 2215B, 2215C are rectangular, while in other embodiments, the connecting members 2215A, 2215B, 2215C may be arched structures or undulating structures as described in FIGS. 21B and 21C or may have any other suitable height, width and/or cross section.

FIGS. 23A and 23B show perspective views of additional embodiments of impact absorbing structures 2300A and 2300B, comprising six support members or filaments coupled to each other by connecting members or walls formed in a hexagonal pattern. In the example shown by FIG. 23A, the impact absorbing structure 2300A has pairs of support members coupled to each other via rectangular connecting members to form a hexagon. The impact absorbing structure 2300B shown by FIG. 23B has pairs of support members coupled to each other via undulating support members to form a hexagon.

FIG. 24 is a perspective view of an impact absorbing structure 2400 comprising rows of offset support members coupled together via connecting members in an “open” polygonal structure. In the example of FIG. 24, support members are positioned in multiple parallel rows 2410, 2420, 2430, 2440, with support members in a row offset from each other so support members in adjacent rows are not in a common plane parallel to the adjacent rows. For example, support members in row 2410 are positioned so they are not in a common plane parallel to support members in row 2420. As shown in the example of FIG. 24, a support member in row 2420 is positioned so it is between support members in row 2410. Connecting members connect support members in a row 2410 to support members in an adjacent row 2420. In some embodiments, support members in a row 2410 are not connected to other support members in the row 2410, but are connected to a support member in an adjacent row 2420 via a support member 2415.

Hexagonal Elements

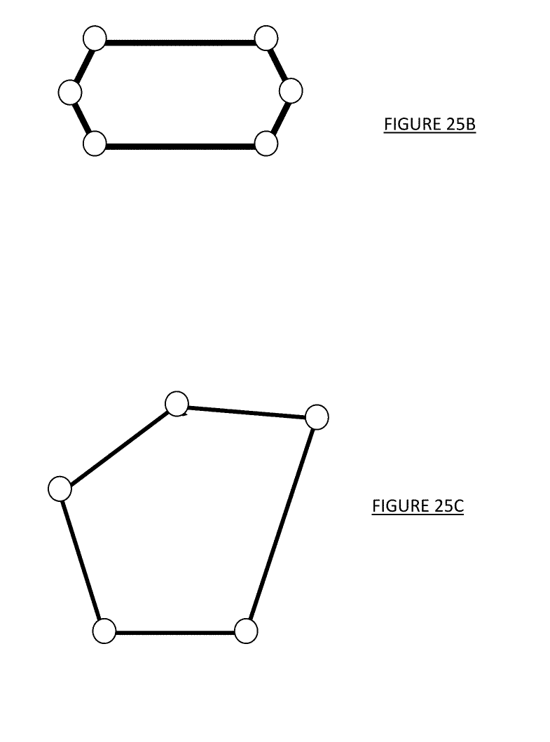

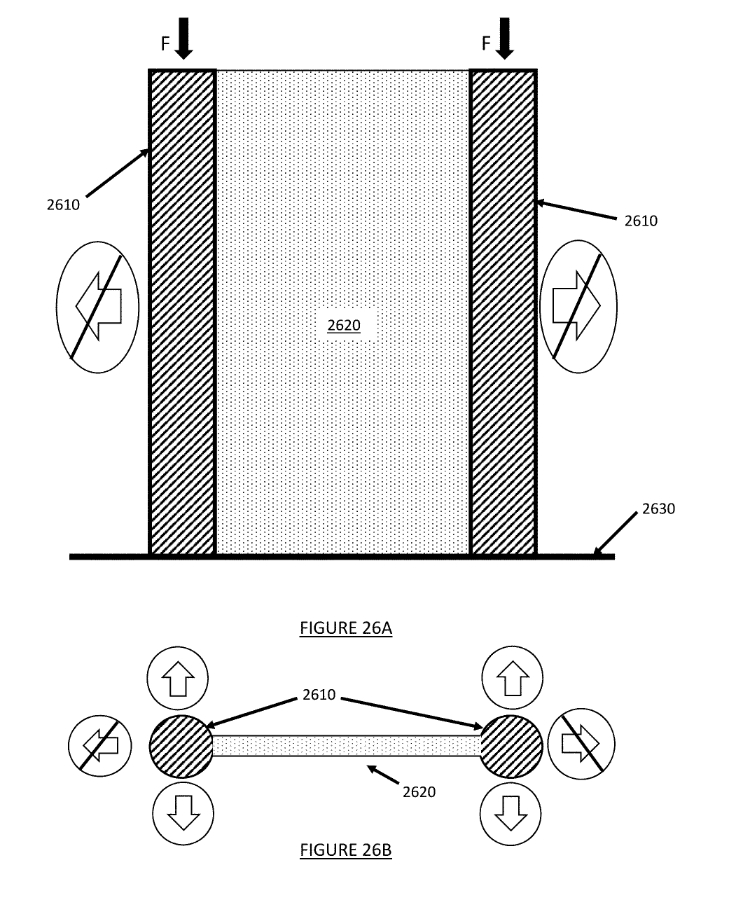

FIG. 25A depicts another view of the exemplary embodiment of an improved impact absorbing element 2500 comprising a plurality of filaments 2510 that are interconnected by laterally positioned walls or sheets 2520 in a hexagonal “closed polygonal” configuration. The hexagonal structures may be manufactured as individual structures or in a patterned array. The manufacturing may include extrusion, investment casting or injection molding process. If manufactured as individual structures, each structure may be affixed to the desired product. Alternatively, if manufactured in a patterned array, the patterned array structures may be affixed to at least one face sheet.

In this embodiment, the filaments can be connected at a lower end and/or an upper end by a face sheet or other structure (not shown), which are/is typically oriented perpendicular to the longitudinal axis of the filaments. A plurality of sheets or lateral walls 2520 can be secured between adjacent pairs of filaments 2510, with each filament having a pair of lateral walls 2520 attached thereto. In the disclosed embodiment, the lateral walls can be oriented approximately 120 degrees apart about the filament axis, with each lateral wall extending substantially along the longitudinal length of the filament. However, in alternative embodiments, an offset hexagonal pattern may be utilized for the filaments and sheets, in which some of the lateral walls may be arranged at 120 degrees, while other walls may be arranged at greater than or less than 120 degrees (see FIG. 25B) or an irregular hexagon pattern may be used (see FIG. 25C), in which the lateral walls are not symmetrical in their positioning and/or arrangement. For any of these embodiments, an upper and/or lower end of the lateral wall may be secured to one or more upper/lower face sheets (not shown), if desired.

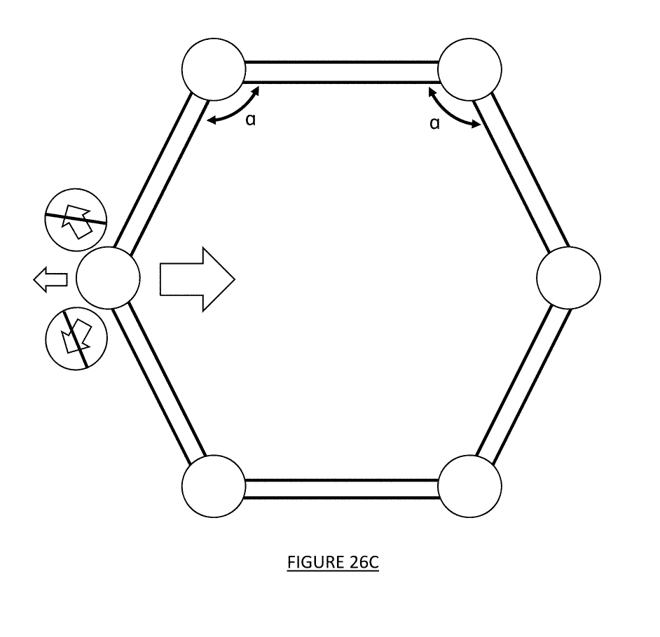

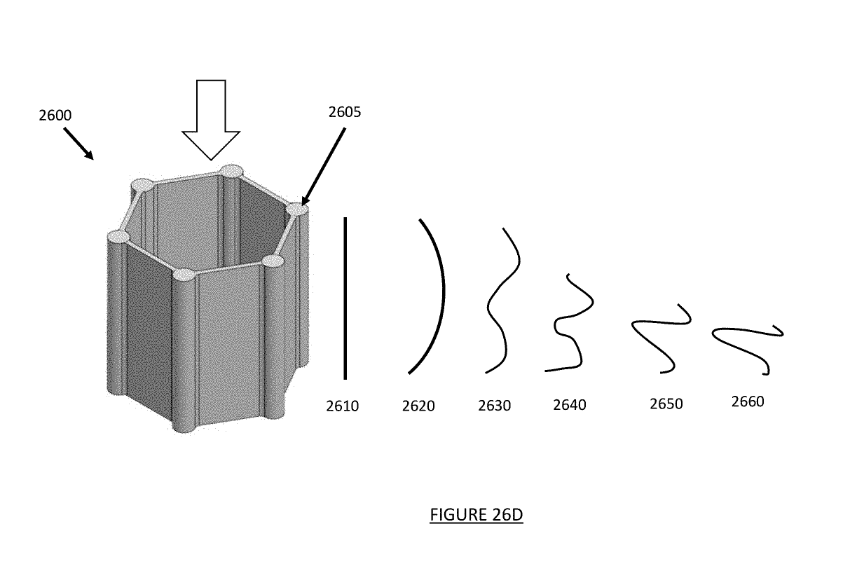

FIG. 26A depicts a side view of an exemplary pair of filaments 2610 that are connected by a lateral wall 2620, with a face sheet 2630 connected at the bottom of the filaments 2610 and wall 2620. In this embodiment, a vertical force (i.e., an axial compressive “impact” F) downward on the filaments 2610 will desirably induce the filaments to compress to some degree in initial resistance to the force F, with a sufficient vertical force eventually inducing the filaments to buckle. However, the presence of the lateral wall 2620 will desirably prevent and/or inhibit buckling of the columns in a lateral direction away from the wall, as well as possibly prevent and/or inhibit sideways buckling of the filaments (and/or buckling towards the wall) to varying degrees—generally depending upon the thickness, structural stiffness and/or material construction of the various walls, as well as various other considerations. As best seen in FIG. 26B, the most likely direction(s) of buckling of the filaments as depicted may be transverse to the wall 2620, which stiffens the resistance of the filaments 2610 to buckling along various lateral directions, to a measurable degree in a desired manner.

FIG. 26C depicts a top plan view of filaments 2610 and walls 2620 in an exemplary hexagonal configuration. In this embodiment, each filament 2610 is connected by walls 2620 to a pair of adjacent filaments, with two walls 2620 extending from and/or between each filament set. In this arrangement, an axial compressive force (not shown) will desirably induce each of the filaments to initially compress to some degree in resisting the axial force, with a sufficient vertical force inducing the filaments to buckle in a desired manner. The presence of the two walls 2620, however, with each wall separated at an approximately 120 degree angle α, tends to limit lateral displacement of each filament away from and/or towards various directions, effectively creating a circumferential or “hoop stress” within the filaments/walls of the hexagonal element under compression that can alter, inhibit and/or prevent certain types, directions and/or degrees of bucking of the individual filaments, of the individual walls and/or of the entirety of the hexagonal structure.

FIG. 26D shows a perspective view of a hexagonal impact absorbing element 2600, with an exemplary progressive mechanical behavior of one filament element 2605 (in this embodiment connected only to a face sheet at its bottom end) as the hexagonal structure undergoes buckling induced by an axial compressive force. In this embodiment, the filament is initially in a generally straightened condition 2610, with the compressive force F initially causing the upper and/or central regions of the filament to displace laterally to some degree 2620 (corresponding to possible stretching, compression and/or “rippling” of the lateral walls), with the central region of the filament bowing slightly outward (causing a portion of the hexagonal structure to assume a slight barrel-like shape). Further compression of the hexagonal element by the force may reach a point where one or more of the filaments begin to buckle 2630, which can include buckling of a portion of the filament inwards towards the center of the hexagonal structure, with other portions of the filament buckling outward (i.e., potentially taking an “accordion” shape as the hexagonal structure buckles), which may be accompanied by asymmetric failure of some or all of the hexagonal structure (i.e., “toppling” or tilting of the hexagonal structure to one side). Further compression of the hexagonal structure should desirably progressively increase the collapse of the filaments 2640, which may include filament and/or wall structures overlapping each other to varying degrees 2650. Eventually, increasing the compressive loading should eventually completely collapse the hexagonal structure and associated filaments/walls 2660, at which point the array may reach a “bottomed out” condition, in which further compression occurs mainly via compressive thinning or elastic/plastic “flowing” of the collapsed material bed (not shown). Desirably, once the compressive load is removed, the individual filaments and/or walls of the hexagonal structure will rebound to approximate their original un-deformed shape, awaiting application of a new load.

In various embodiments, the presence of the lateral walls between the filaments of the hexagonal structure can greatly facilitate recovery and/or rebound of the filament and hexagonal elements as compared to the independent filaments within a traditional filament bed. During buckling and collapse of the filaments and hexagonal structures, the lateral walls desirably constrain and control filament “failure” in various predictable manners, with the walls and/or filaments elastically deforming in various ways, similar to the “charging” of a spring, as the hexagonal structure collapses. When the compressive force is released from the hexagonal structure, the walls and filaments should elastically deform back to their original “unstressed” or pre-stressed sheet-like condition, which desirably causes the entirety of the hexagonal structure and associated filaments/walls to quickly “snap back” to their original position and orientation, immediately ready for the next compressive force.

The disclosed embodiments also confer another significant advantage over current filament array designs, in that the presence, orientation and dimensions of the lateral walls and attached filaments can confer significant axial, lateral and/or torsional stability and/or flexibility to the entirety of the array, which can include the creation of orthotropic impact absorbing structures having unique properties when measured along different directions. More importantly, one unique features of these closed polygonal structures (and to some extent, open polygonal structures in various alternative configurations) is that the orthotropic properties of the hexagonal structures and/or the entirety of the impact absorbing array can often be “tuned” or “tailored” by alterations and/or changes in the individual structural elements, wherein the alteration of one element can significantly affect one property (i.e., axial load resistance and/or buckling strength) without significantly altering other properties (i.e., lateral and/or torsional resistance of the structural element). In various embodiments, this can be utilized to create a protective garment that responds differently to different forces acting in different areas of the garment.

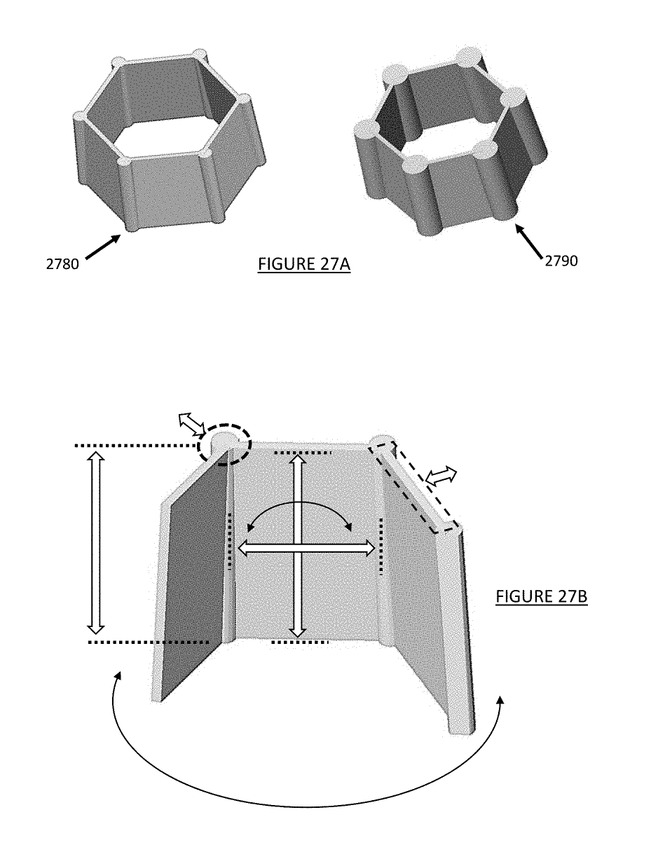

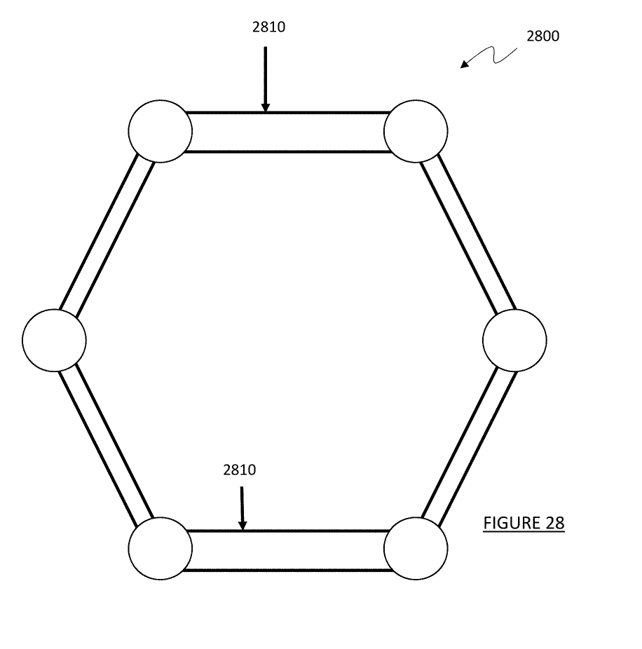

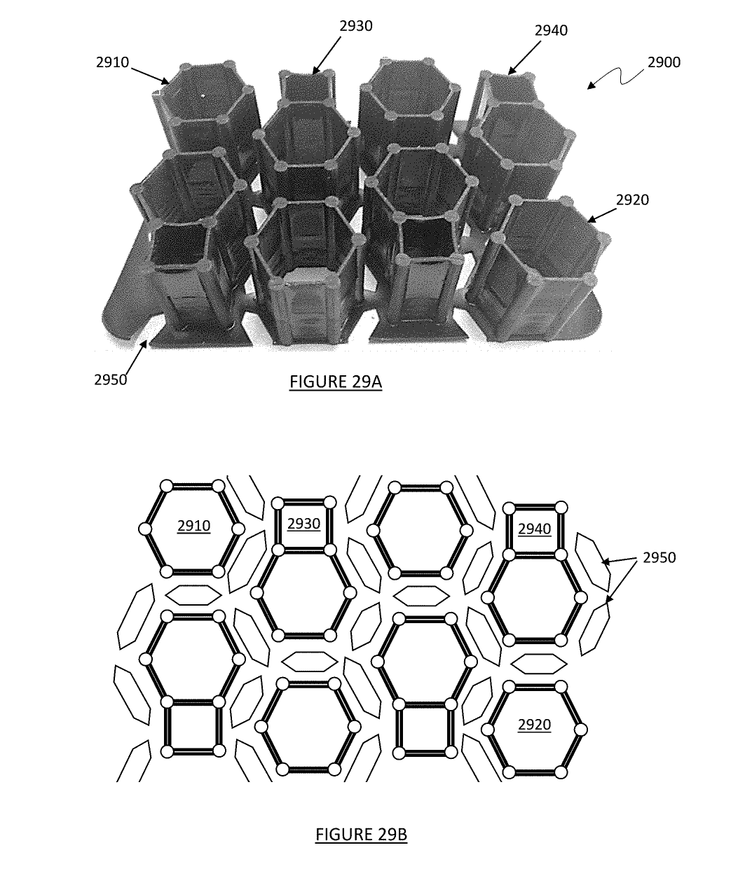

Desirably, alterations in the structural, dimensional and/or material components of a given design of an array element will alter some component(s) of its orthotropic response to loading. For example, FIG. 27A depicts a first hexagonal element 2780 having relatively small diameter filaments of a certain length, and a second hexagonal element 2790 having relatively larger diameter filaments of the same height or offset. When incorporated into respective impact absorbing arrays of repeating elements of similar design, these elements would desirably perform equivalently in torsional and/or shear loading, with the second array (i.e., having the array having the second hexagonal elements 2790) having greater resistance to deformation and/or buckling under axial compressive loading than the first array (having the first hexagonal elements). In a similar manner, the thickness, dimensions and/or material composition of the lateral walls can have significant impact on the lateral and/or torsional response of the structure, with alterations in these structures desirably increasing, decreasing and/or otherwise altering the resistance of the element's torsional and/or lateral loading response, while minimizing changes to the axial compression response.

In various embodiments, a hexagonal or other shaped structure may have a straight, curved and/or tapered configuration (or various combinations thereof). For a tapered configuration, the hexagonal structure can have a top surface and a bottom surface, wherein the bottom surface perimeter (and/or bottom surface thickness/diameter of the individual elements) may be larger than the corresponding top surface perimeter (and/or individual element thickness/diameter). In various embodiments, this can include a hexagonal element (or other shaped element) having a frustum shape.

If desired, the hexagonal elements of an impact absorbing array can include components of varying size, shape and/or material within a single element, such as filaments and/or walls of different diameter and/or shape within a single element and/or within an array of repeating elements. For example, the orthotropic response of the hexagonal element 2800 depicted in FIG. 28 can be altered by increasing the thickness of one set of lateral walls 2810, while incorporating thinner lateral walls 2420 in the remaining lateral walls, if desired. This can have the effect of “stiffening” the lateral and/or torsional response of the structure in one or more directions, while limiting changes to the axial response. As show in FIG. 27B, a wide variety of structural features and dimensions, as well as material changes, can be utilized to “tune” or “tailor” the element to a desired performance, which could include in-plane and/or out-of-plane rotation of various hexagonal elements relative to the remainder of elements within an array.

In various embodiments, one or more array elements could comprise non-symmetrical open and/or closed polygonal structures, including polygonal structures of differing shapes and/or sizes in a single impact absorbing array. For example, FIGS. 29A and 29C depict top and bottom perspective views of one embodiment of an impact absorbing array 2900 incorporating closed polygonal elements, including hexagonal elements 2910 and 2920, and square elements 2930 and 2940. FIG. 29B depicts a simplified top plan view of the array of FIG. 29A. If desired, the individual polygonal elements can be spaced apart and/or attached to each other at various locations, including proximate the peripheral edges of the array (which may allow for attachment of “stray” elements and/or filaments near the edges of the array, where a complete repeating pattern of a single polygonal element design may be difficult and/or impossible to achieve). Also depicted are various holes or perforations 2950 in the lower face sheet, which desirably reduce the weight of the face sheet and can also significantly increase the flexibility of the face sheet and the resulting impact absorbing array. These perforations may be positioned in a repeating pattern of similar size and/or shaped holes, or the perforations may comprise a variety of shapes, sizes and/or orientations in the face sheet of a single array. The perforated face sheet may be directly affixed to the product (e.g., protective garment, trauma plate insert and/or other item) or a thin-walled polycarbonate backsheet may be additionally affixed to the perforated face sheet. The perforated face sheet may have a back surface where the polycarbonate backsheet may be affixed. The polycarbonate backsheet may improve load distribution throughout the hexagonal structures, may provide more comfort for direct contact with the wearer and/or may assist with a more uniform adherence to the product.

FIG. 30A depicts an exemplary impact absorbing array comprising a plurality of hexagonal elements 3000 in a generally repeating symmetrical arrangement. In this embodiment, the elements 3000 are connected to each other by a lower face sheet 3005, which can optionally include connection by a pierced or “lace-like” lower face sheet (not shown), if desired. An upper portion of each of the elements 3000 in this embodiment is desirably not connected by an upper face sheet, which consequently allows the lower face sheet 3010 (and thus the array) to easily be bent, twisted and/or otherwise shaped or “flexed” to follow a hemispherical, curved or irregular shape (See FIG. 30B), including an ability to deform the lower sheet and associated array elements around corners and/or edges or other complex surfaces, if desired. In this manner, the array elements can be manufactured in sheet form, if desired, and then the array sheet can be manipulated to conform to a desired shape (i.e., the gently curved hemispherical shape of a chest wall of the wearer, for example) without significantly affecting the shape and/or impact absorbing performance of the hexagonal elements therein. In some embodiments, the lower face sheet may curve smoothly, while in other embodiments the lower face sheet may curve and/or flex primarily at locations between hexagonal or other elements, while maintaining a relatively flat profile underneath individual polygonal elements.

In various alternative embodiments, an upper face sheet can be connected to the upper portion of the elements, if desired. In such arrangements, the upper face sheet could comprise a substantially flexible material that allows flexing of the array in a desired manner, or the upper face sheet could be a more rigid material comprising one or more attachments that are attached to the array after flexing and/or other manipulation of the lower face sheet and associated elements has occurred, thereby allowing the array to be manufactured in a flat-sheet configuration.

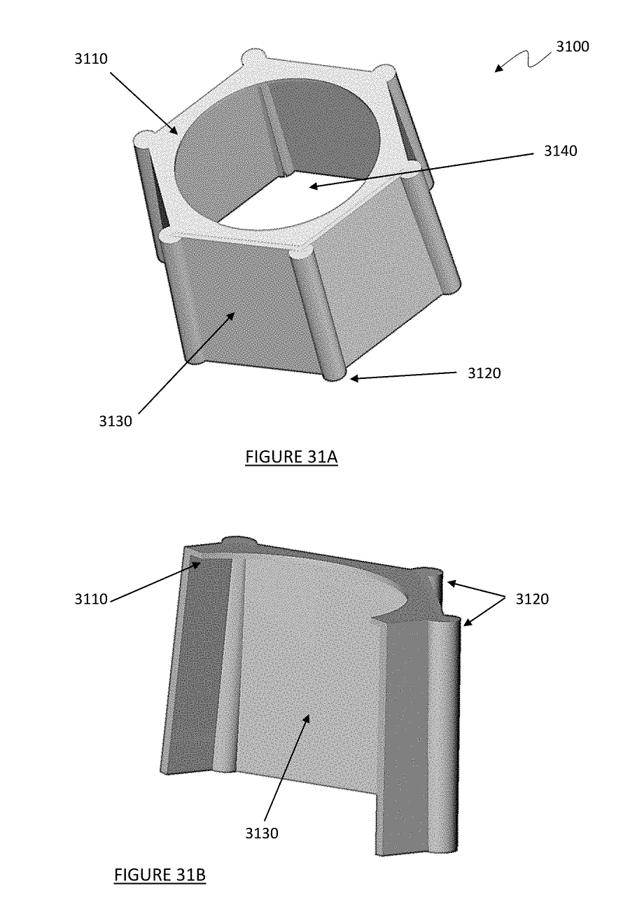

FIGS. 31A and 31B depict perspective and cross-sectional views of one alternative embodiment of a hexagonal impact absorbing element 3100, which incorporates an upper ridge 3110 at the upper end of the filaments 3120, with the upper ridge connected to the upper ends of the filaments and upper portions of the lateral walls 3130. In this embodiment, the upper ridge 3110 can include an open or perforated central section 3140, which in alternative embodiments could be formed in a variety of opening shapes and/or configurations, including circular, oval, triangular, square, pentagonal, hexagonal, septagonal, octagonal and/or any other shape, including shapes that mimic or approximate the shape of the polygonal element. In other alternative embodiments, the upper ridge could comprise a continuous sheet that covers the entirety of the upper surface of the element, or could include a plurality of perforations or holes (i.e., a perforated regular or irregular lattice and/or lace-like structure).

One significant advantage of incorporating an upper ridge into the hexagon element is a potential increase in the “stiffness” and rebound force/speed of the hexagon element as compared to the open elements of FIG. 25A. The addition of the upper ridge can, in various configurations, function in some ways similar to an upper face sheet attached to the element, in that the upper ridge can constrain movement of the upper end of the filaments in various ways, and also serve to stiffen the lateral walls to some degree. This can have the desired effect of altering the response of the element to lateral and/or torsional loading, with various opening sizes, configurations and sheet thickness having varying effect on the lateral and/or torsional response. Moreover, the addition of the upper ridge can increase the speed and/or intensity at which the element (and/or components thereof) “rebounds” from a compressed, buckled and/or collapsed state, which can improve the speed at which the array can accommodate repeated impacts. In addition, the incorporation of the upper ridge can reduce stress concentrations that may be inherent in the various component connections during loading, including reducing the opportunity for plastic flow and/or cracking/fracture of component materials during impacts and/or repetitive loading.

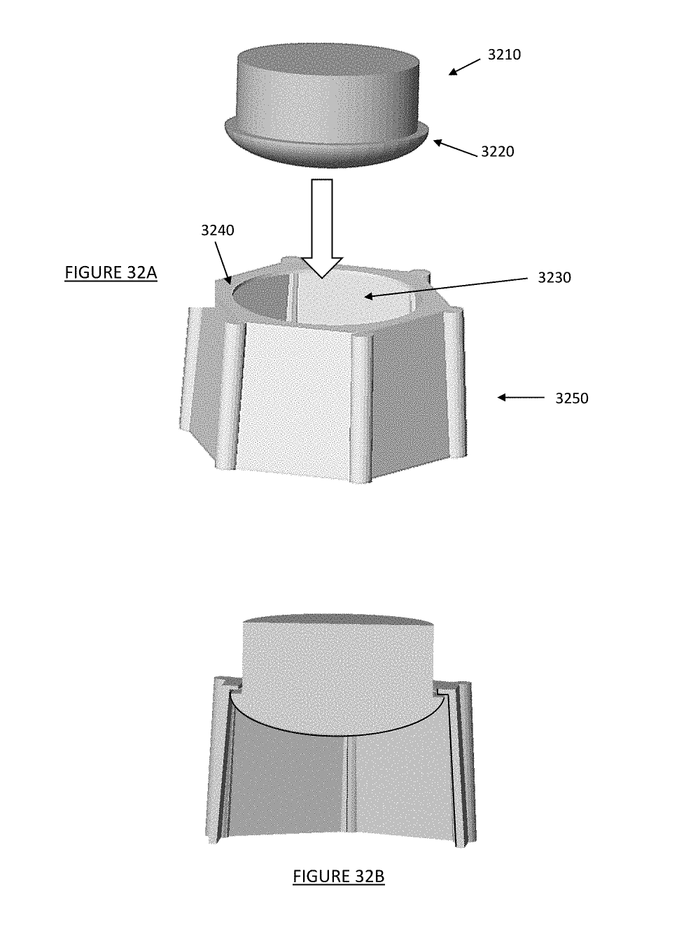

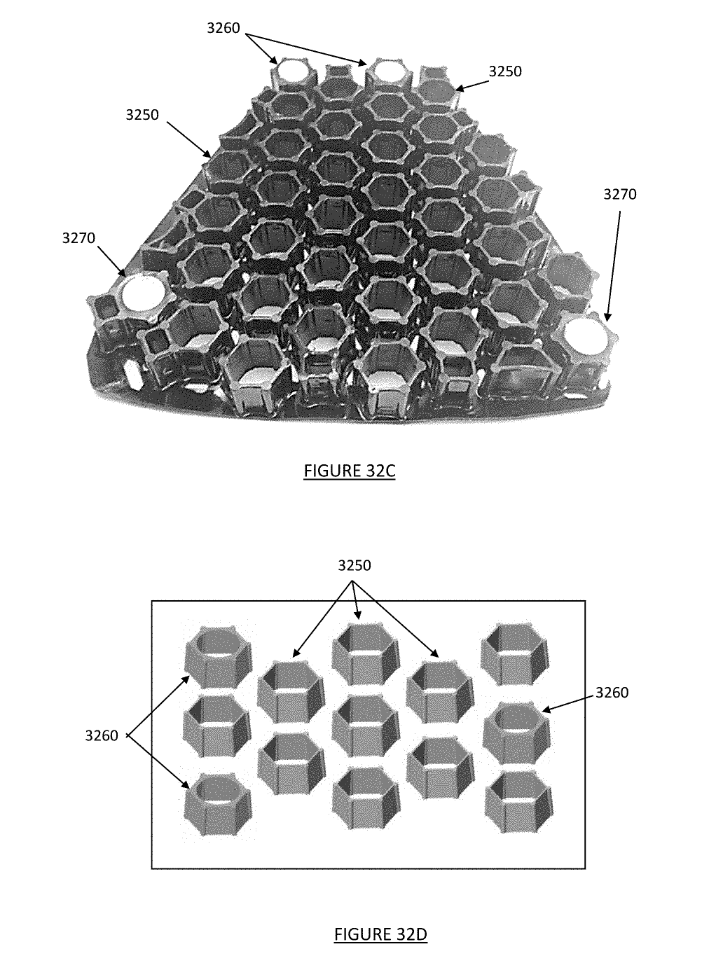

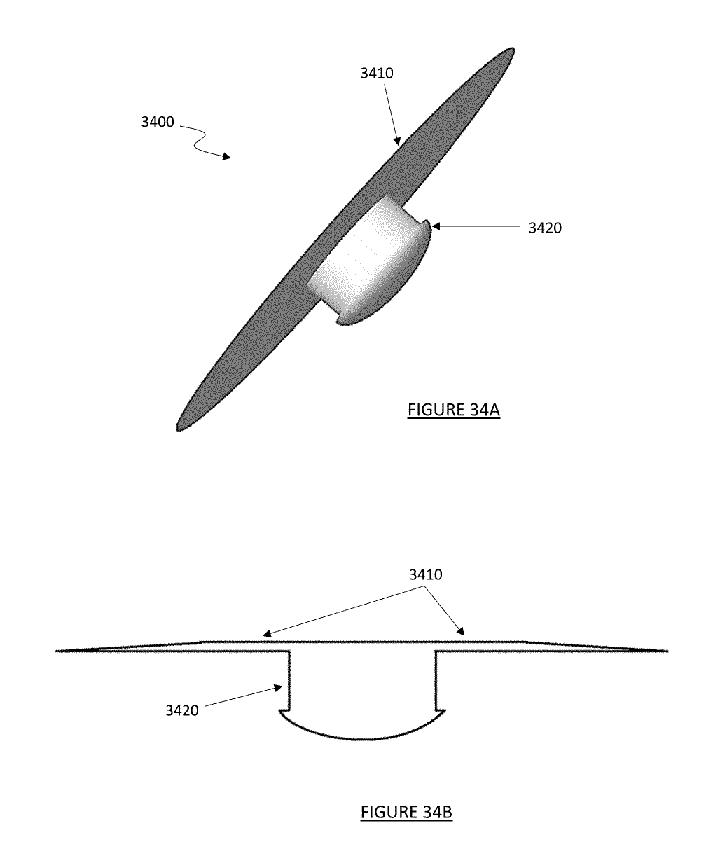

The incorporation of the upper ridge can also facilitate connection of the upper end of the element to another structure, such as an inner surface of a protective garment or other item of protective clothing, or to one or more impact elements or trauma plates (including one or more “floating” or fixed plates). FIG. 32A depicts an engagement insert, grommet or plug 3210 having an enlarged tip 3220 that is desirably slightly larger than the opening 3230 in the upper ridge 3240 of the hexagonal element 3250. In use, the enlarged tip 3220 can desirably be pushed through the opening 3230, with the tip and/or opening comprising a material sufficiently flexible to permit the tip and/or opening to deform slightly and, once the tip is through the opening, allows the tip and an inner surface of the ridge to engage, which desirably retains the tip within the element 3250 (with the plug 3210 desirably attached or secured to some other item such as the surface of an impacting element)—see FIG. 32B. If desired, the inner surface of the ridge and/or the engaging surface of the tip could include a flat and/or saw-tooth configuration, for greater retention force. In various embodiments, the plug may be connected to a rigid impacting disc of round, oval and/or hexagonal shape (see FIG. 34A), which could include an adjustable and/or sliding connector (not shown), for greater flexibility and/or comfort for the wearer.

In various embodiments, an impact absorbing array of hexagonal and/or other shaped elements can comprise one or more elements having an upper ridge engagement feature for securement of the array to an item of clothing or other structure. For example, FIGS. 32C and 32D depict alternative impact absorbing array configurations in which a series of hexagonal elements 3250 are bounded at various edges by hexagonal engaging elements 3260, which can desirably be engaged with plugs or other inserts 3270 for securement to other items.

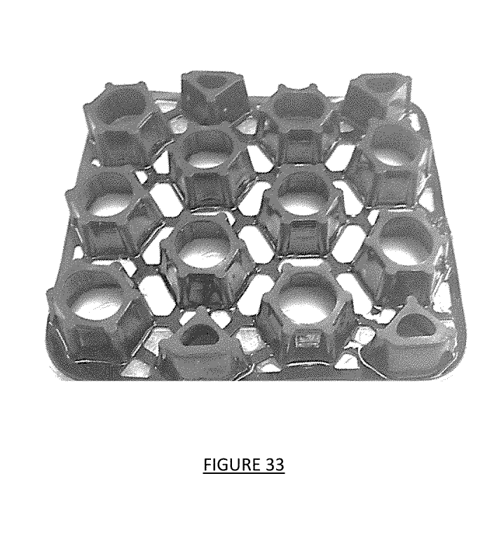

FIG. 33 depicts another alternative embodiment of an impact absorbing array comprising fourteen regularly-spaced elements, 10 of which are hexagonal and 4 of which are approximately triangular elements, with all of the depicted elements including an upper ridge structure that could permit the element to be utilized as an engaging element. As depicted, the hexagonal and triangular elements each desirably utilize a different design, size, shape and/or other arrangements of plugs (not shown). If both differing plug types were utilized on protective garment, then the array for attachment thereto might need to be properly oriented and/or positioned relative to the plugs before attachment could be accomplished, which could ensure proper placement and/or orientation of the array in a desired location in the protective which corresponds to the different plugs for the triangular and hexagonal elements.

FIGS. 34A and 34B depict perspective and cross-sectional side views of one exemplary embodiment of a “floating” impact element 3400 for use with various of the IAS arrays described herein. In this embodiment, the impact element 3400 comprises a disc-shaped impacting surface or body 3410, which is connected at a bottom surface to a plug 3420 (or plurality of plugs—not shown). Desirably, a plurality of impact elements 3400 can be attached to the individual ridged hexagonal elements of an IAS array as described herein, with the impacting elements optionally positioned in an imbricated pattern (which could optionally include IAS elements of differing heights in a single array to accommodate the imbricated pattern), and the array incorporated into a protective vest or other item of clothing. Such a design could potentially allow a wearer to survive a high velocity impact on the garment, and then potentially repair/replace any broken or damaged impact elements “in the field,” thereby allowing immediate resumption of garment protection and effectiveness.

In various embodiments, the patterns of element placement and spacing of elements could vary widely, including the use of regular and/or irregular spacing or element placement, as well as higher and/or lower densities of elements in particular locations on a given array. For a given element design, size and/or orientation, the different patterns and/or spacing of the elements will often significantly affect the impact absorption qualities and/or impact response of the array, which provides the array designer with an additional set of configurable qualities for tuning and/or tailoring the array design such that a desired impact performance is obtained (or optimized) from an array which is sized and configured to fit within an available space in a protective garment.

In various alternative embodiments, composite impact absorbing arrays could be constructed that incorporate various layers of materials, including one or more impact absorbing array layers incorporating closed and/or open polygonal element layers and/or other lateral wall supports. Desirably, composite impact absorbing arrays could be utilized to replace and/or retrofit existing impact absorbing layer materials in protective clothing other items, as well as for non-protective clothing uses including, but not limited to, floor mats, shock absorbing or ballistic blankets, armor panels, packing materials and/or surface treatments. In many cases, impact absorbing arrays such as described herein can be designed to provide superior impact absorbing performance to an equivalent or lesser thickness of foam or other cushioning materials being currently utilized in impact absorbing applications. Where existing impact absorbing materials can be removed from an existing item (a military “flak jacket” or other body armor, for example), one or more replacement impact absorbing arrays and/or composite arrays, such as those described herein, can be designed and retro-fitted in place of the removed material(s), desirably improving the protective performance of the item.

Depending upon layer design, material selections and required performance characteristics, impact absorbing arrays incorporating closed and/or open polygonal element layers and/or other lateral wall supports such as described herein can often be designed to incorporate a lower offset (i.e., a lesser thickness) than a layer of foam or other impact absorbing materials providing some equivalence in performance. This reduction in thickness has the added benefit of allowing for the incorporation of additional thicknesses of cushioning or other materials in a retrofit and/or replacement activity, such as the incorporation of a thin layer of comfort foam or other material bonded or otherwise positioned adjacent to the replacement impact absorbing array layer(s), with the comfort foam in contact with the wearer's body. Where existing materials are being replaced on an item (i.e., retro-fitted to a protective vest or other protective clothing item), this could result in greatly improved impact absorbing performance of the item, improvement in wearer comfort and potentially a reduction in item weight and/or bulk. Alternatively, where a new item is being designed, the incorporation of the disclosed impact absorbing array layer(s) can allow the new item to be smaller and/or lighter that its prior counterpart, often with a concurrent improvement in performance and/or durability.

In various embodiments, an array can be designed that incorporates open and/or closed polygonal elements of different heights or offsets in individual elements within a single array. Such designs could be particularly useful when replacing and/or retrofitting an existing item of protective clothing, in that the impact absorbing array might be able to accommodate variations in the height of the space available for the replacement array. In such a case, the lower face sheet of the replacement array might be formed into a relatively flat, uniform surface, with the upper ends of the hexagonal elements therein having greater or lesser offsets, with longer elements desirably fitting into deeper voids in the inner surface of the protective item. When assembled, the lower face sheet of the replacement array may be bent into a spherical or semispherical surface (desirably corresponding to the wearer's anatomy), with the upper surfaces of the elements facing outwards towards the environment.

Intelligent Armor

If desired, protective garment designs could incorporate programmable and/or reprogrammable features to accommodate training (i.e., increased training resistance at certain points in an activity cycle) and/or performance enhancement (i.e., for assisting a wearer to accomplish various athletic endeavors that require modification and/or assistance from one or more IAS arrays). If desired, a protective garment could include sensor features that might allow a computer to “predict” potential desired IAS characteristics, and the system could alter IAS array performance based on outside factors (i.e., changing the IAS array performance to a softer, more flexible setting when a soldier is within a protected environment like a tank or bunker, or stiffening the IAS response when the soldier is out of their vehicle and/or running in open combat). The IAS array could also include sensors that identify when combat is occurring or is imminent (i.e., sound sensor to identify gunfire or the whistling sound of incoming mortar rounds) and potentially take action to modify IAS array performance and/or characteristics.

In a similar manner, protective garment designs could be particularized for different individuals or situations that require different impact responses, such as situations where a soldier may be expected to run, crawl and/or swim in a single engagement, and the garment could potentially be optimized using a single adaptable IAS design. In one exemplary example, an IAS array could incorporate external fittings and/or sensors to identify a particular running motion (i.e., an accelerometer to identify running), or swimming activity (i.e., a temperature or humidity sensor to identify when the garment is immersed in water), with the IAS array altering its flexibility and/or performance to desirably assist the soldier in accomplishing the desired activity.

While many of the embodiments are described herein as constructed of polymers or other plastic and/or elastic materials, it should be understood that any materials known in the art could be used for any of the devices, systems and/or methods described in the foregoing embodiments, for example including, but not limited to metal, metal alloys, combinations of metals, plastic, polyethylene, ceramics, cross-linked polyethylene's or polymers or plastics, and natural or man-made materials. In addition, the various materials disclosed herein could comprise composite materials, as well as coatings thereon.

### INCORPORATION BY REFERENCE

The entire disclosure of each of the publications, patent documents, and other references referred to herein is incorporated herein by reference in its entirety for all purposes to the same extent as if each individual source were individually denoted as being incorporated by reference.

### EQUIVALENTS

The invention may be embodied in other specific forms without departing from the spirit or essential characteristics thereof. The foregoing embodiments are therefore to be considered in all respects illustrative rather than limiting on the invention described herein. The scope of the invention is thus intended to include all changes that come within the meaning and range of equivalency of the descriptions provided herein.

Many of the aspects and advantages of the present invention may be more clearly understood and appreciated by reference to the accompanying drawings. The accompanying drawings are incorporated herein and form a part of the specification, illustrating embodiments of the present invention and together with the description, disclose the principles of the invention.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the disclosure herein.

What is claimed:

1. A protective garment comprising
an inner layer;
an outer layer spaced apart from the inner layer defining a space, at least a portion of the outer layer comprising a plurality of substantially inflexible plates, the plurality of substantially inflexible plates arranged in an imbricated pattern;
an interface layer disposed in the space between the inner layer and the outer layer, the interface layer comprising a plurality of filaments, each of the plurality of filaments comprising a first end proximal to the inner layer and a second end proximal to the outer layer;
wherein at least a portion of the plurality of filaments are configured to deform non-linearly in response to an external incident force on the outer layer.

2. The protective garment of claim 1, wherein each of the plurality of filaments further comprises a lateral wall extending outwardly therefrom to at least one adjacent filament.

3. The protective garment of claim 1, wherein the plurality of substantially inflexible plates are directly secured the second ends of the plurality of filaments.

4. The protective garment of claim 1, wherein the inner layer or outer layer further comprises at least one ballistic fabric layer.

5. The protective garment of claim 1, wherein the interface layer disposed in the space between the inner layer and the outer layer comprises a first interface layer and a second interface layer, the first interface layer comprising a plurality of first filaments having a first configuration and the second interface layer comprising a plurality of second filaments having a second configuration, the first configuration being different than the second configuration.

6. The protective garment of claim 5, wherein the first interface layer overlies the second interface layer.

7. The protective garment of claim 5, wherein the first interface layer is positioned adjacent to the second interface layer.

8. The protective garment of claim 1, wherein the interface layer comprises a plurality of filaments arranged and configured in a plurality of hexagonally configured elements, each of the plurality of filaments including a lateral wall extending outwardly therefrom to at least one adjacent filament.

9. The protective garment of claim 8, wherein the plurality of hexagonally configured elements are frustum-shaped.

10. The protective garment of claim 1, wherein the inner layer and outer layer further comprises at least one ballistic fabric layer.

11. A protective garment comprising
an inner layer;
an outer layer spaced apart from the inner layer defining a space, at least a portion of the outer layer comprising a plurality of substantially inflexible plates, the plurality of substantially inflexible plates arranged in an overlapping pattern;
an interface layer disposed in the space between the inner layer and the outer layer, the interface layer comprising a plurality of filaments, each of the plurality of filaments comprising a first end proximal to the inner layer and a second end proximal to the outer layer;
wherein at least a portion of the plurality of filaments are configured to deform non-linearly in response to an external incident force on the outer layer.

12. The protective garment of claim 11, wherein each of the plurality of filaments further comprises a lateral wall extending outwardly therefrom to at least one adjacent filament.

13. The protective garment of claim 11, wherein each of the plurality of substantially inflexible plates is directly secured to at least one of the plurality of filaments.

14. The protective garment of claim 11, wherein the interface layer disposed in the space between the inner layer and the outer layer comprises a first interface layer and a second interface layer, the first interface layer comprising a plurality of first filaments having a first configuration and the second interface layer comprising a plurality of second filaments having a second configuration, the first configuration being different than the second configuration.

15. The protective garment of claim 14, wherein the first interface layer overlies the second interface layer or the first interface layer is positioned adjacent to the second interface layer.

16. The protective garment of claim 11, wherein the interface layer comprises a plurality of filaments arranged and configured in a plurality of hexagonally configured elements, each of the plurality of filaments including a lateral wall extending outwardly therefrom to at least one adjacent filament.

17. The protective garment of claim 16, wherein the plurality of hexagonally configured elements are frustum-shaped.

18. The protective garment of claim 11, wherein the inner layer or outer layer further comprises at least one ballistic fabric layer.

19. The protective garment of claim 1, wherein the inner layer and outer layer further comprises at least one ballistic fabric layer.
